(19) United States
(12) Patent Application Publication
(10) Pub. No.: US 2025/0262853 A1
(43) Pub. Date: Aug. 21, 2025

(54) LIQUID EJECTING APPARATUS AND CONTROL METHOD FOR LIQUID EJECTING APPARATUS

(71) Applicant: SEIKO EPSON CORPORATION, Tokyo (JP)

(72) Inventors: Akira MIYAGISHI, SHIOJIRI-SHI (JP); Hiroaki OKUI, AZUMINO-SHI (JP); Nobuaki ITO, SUWA-SHI (JP)

(21) Appl. No.: 19/055,580

(22) Filed: Feb. 18, 2025

(30) Foreign Application Priority Data
Feb. 20, 2024 (JP) 2024-023648

(51) Int. Cl. B41J 2/045; B41J 2/14

(52) U.S. Cl. CPC B41J 2/04525; B41J 2/04581; B41J 2/04588; B41J 2/14233

(57) ABSTRACT

A liquid ejecting apparatus includes a liquid ejecting head that includes a detection circuit which detects residual vibration of a diaphragm caused by driving of at least one of a first piezoelectric element and a second piezoelectric element corresponding to nozzles, and an evaluation control portion, in which the evaluation control portion causes the detection circuit to detect first residual vibration caused by driving the first piezoelectric element and the second piezoelectric element with a drive signal for ejecting an ink, from the first piezoelectric element, causes the detection circuit to detect second residual vibration caused by driving the first piezoelectric element with the drive signal and driving the second piezoelectric element with another drive signal for not ejecting the ink, from the first piezoelectric element, and evaluates crosstalk between the nozzles based on the first residual vibration and the second residual vibration detected by the detection circuit.

The present application is based on, and claims priority from JP Application Serial Number 2024-023648, filed Feb. 20, 2024, the disclosure of which is hereby incorporated by reference herein in its entirety.

### BACKGROUND

### 1. Technical Field

The present disclosure relates to a liquid ejecting apparatus and a control method for the liquid ejecting apparatus.

### 2. Related Art

A liquid ejecting apparatus that prints an image by causing a nozzle to eject a liquid such as an ink by using a piezoelectric element is known. For example, the liquid ejecting apparatus includes a liquid ejecting head that causes the nozzle to eject the liquid with which a pressure chamber is filled, by vibrating a diaphragm that constitutes a part of the pressure chamber by the piezoelectric element. In this type of liquid ejecting apparatus, a problem is known in which so-called structural crosstalk occurs in which an ejection characteristic of one nozzle among a plurality of nozzles varies depending on an ejection state of another nozzle such as a nozzle adjacent to the one nozzle. Various techniques for preventing the occurrence of the structural crosstalk are proposed. For example, JP-A-2011-88279 discloses a waveform of an ejection drive pulse for ejecting a liquid from a nozzle, the waveform reducing structural crosstalk.

Meanwhile, a cause of the occurrence of the crosstalk is changed depending on a use condition of the liquid ejecting head in addition to a structure of the liquid ejecting head. For example, the cause of the occurrence of the crosstalk is also changed depending on an ink condition such as a type of ink. Here, for example, a business model in which a head manufacturer that manufactures a liquid ejecting head sells the liquid ejecting head to a printing apparatus manufacturer, and the printing apparatus manufacturer assembles a liquid ejecting apparatus is considered. In the business model, in many cases, a use condition of the liquid ejecting head such as an ink condition is determined by the printing apparatus manufacturer, not the head manufacturer. When the head manufacturer assembles the liquid ejecting apparatus, the head manufacturer also determines the use condition, and thus, evaluation of crosstalk can be appropriately executed. On the other hand, in the business model described above, there is a concern that the head manufacturer may not be able to appropriately evaluate crosstalk at a stage at which the head manufacturer manufactures and sells the liquid ejecting head. In that case, it is difficult for the head manufacturer to determine an appropriate waveform of a drive signal for preventing the occurrence of crosstalk. Therefore, in the business model described above, the printing apparatus manufacturer needs to determine the appropriate evaluation of crosstalk and the appropriate waveform of the drive signal for preventing the occurrence of crosstalk, and there is a concern that this may cause an excessive load on the printing apparatus manufacturer. Therefore, in the business model described above, it is desired that the evaluation of the crosstalk and the determination of the waveform of the drive signal for driving a piezoelectric element can be appropriately and easily performed. In particular, it is desired to be able to evaluate crosstalk appropriately and easily. The problems described above are desired to be relatively small even when a manufacturer that manufactures the liquid ejecting apparatus and a manufacturer that manufactures the liquid ejecting head have the same business model. For example, it is conceivable that a user sets a use condition different from a use condition assumed in advance by the manufacturer of the liquid ejecting head or the liquid ejecting apparatus, and in this case, the same problem occurs.

### SUMMARY

According to an aspect of the present disclosure, there is provided a liquid ejecting apparatus including: a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element; and a control portion, in which the control portion causes the detection portion to detect, as first residual vibration, the residual vibration caused by driving the first piezoelectric element and the second piezoelectric element with an ejection signal for ejecting the liquid, from the first piezoelectric element, causes the detection portion to detect, as second residual vibration, the residual vibration caused by driving the first piezoelectric element with the ejection signal and driving the second piezoelectric element with a holding signal for not ejecting the liquid, from the first piezoelectric element, and evaluates crosstalk between the first nozzle and the second nozzle based on the first residual vibration and the second residual vibration detected by the detection portion.

According to another aspect of the present disclosure, there is provided a liquid ejecting apparatus including: a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element; and a control portion, in which the control portion causes the detection portion to detect, as first residual vibration, the residual vibration caused by driving the first piezoelectric element and the second piezoelectric element with an ejection signal for ejecting the liquid, from the first piezoelectric element, causes the detection portion to detect, as second residual vibration, the residual vibration caused by driving the first piezoelectric element with the ejection signal and driving the second piezoelectric element with a holding signal for not ejecting the liquid, from the first piezoelectric element, and determines a waveform of the ejection signal and a waveform of the holding signal based on the first residual vibration and the second residual vibration detected by the detection portion.

According to still another aspect of the present disclosure, there is provided a control method for a liquid ejecting apparatus including a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element, the method including: causing the detection portion to detect, as first residual vibration, the residual vibration caused by driving the first piezoelectric element and the second piezoelectric element with an ejection signal for ejecting the liquid, from the first piezoelectric element; causing the detection portion to detect, as second residual vibration, the residual vibration caused by driving the first piezoelectric element with the ejection signal and driving the second piezoelectric element with a holding signal for not ejecting the liquid, from the first piezoelectric element; and evaluating crosstalk between the first nozzle and the second nozzle based on the first residual vibration and the second residual vibration detected by the detection portion.

### BRIEF DESCRIPTION OF THE DRAWINGS

FIG. 1 is a block diagram illustrating an example of a configuration of a liquid ejecting apparatus according to an embodiment of the present disclosure.

FIG. 2 is a configuration diagram schematically illustrating the liquid ejecting apparatus.

FIG. 3 is an exploded perspective view of a liquid ejecting head.

FIG. 4 is a cross-sectional diagram taken along a line IV-IV in FIG. 3.

FIG. 5 is a block diagram illustrating an example of a configuration of the liquid ejecting head.

FIG. 6 is an explanatory diagram describing crosstalk.

FIG. 7 is a timing chart illustrating an example of an operation of the liquid ejecting apparatus in a unit period.

FIG. 8 is a diagram illustrating an example of a waveform of a residual vibration signal.

FIG. 9 is a flowchart illustrating an example of an operation of the liquid ejecting apparatus when evaluating crosstalk.

FIG. 10 is a flowchart illustrating an example of a comparison process of residual vibration illustrated in FIG. 9.

FIG. 11 is a block diagram illustrating an example of a configuration of a liquid ejecting head according to a first modification example.

FIG. 12 is a timing chart illustrating an example of an operation of a liquid ejecting apparatus according to the first modification example.

### DESCRIPTION OF EMBODIMENTS

Hereinafter, embodiments for carrying out the present disclosure will be described with reference to the drawings. Meanwhile, in each drawing, the size and scale of each portion are appropriately different from the actual ones. The embodiments described below are preferred specific examples of the present disclosure and are thus added with technically preferred various limitations, but the scope of the present disclosure is not limited to such embodiments unless description for limiting the present disclosure is made in the following description.

### 1. Embodiment

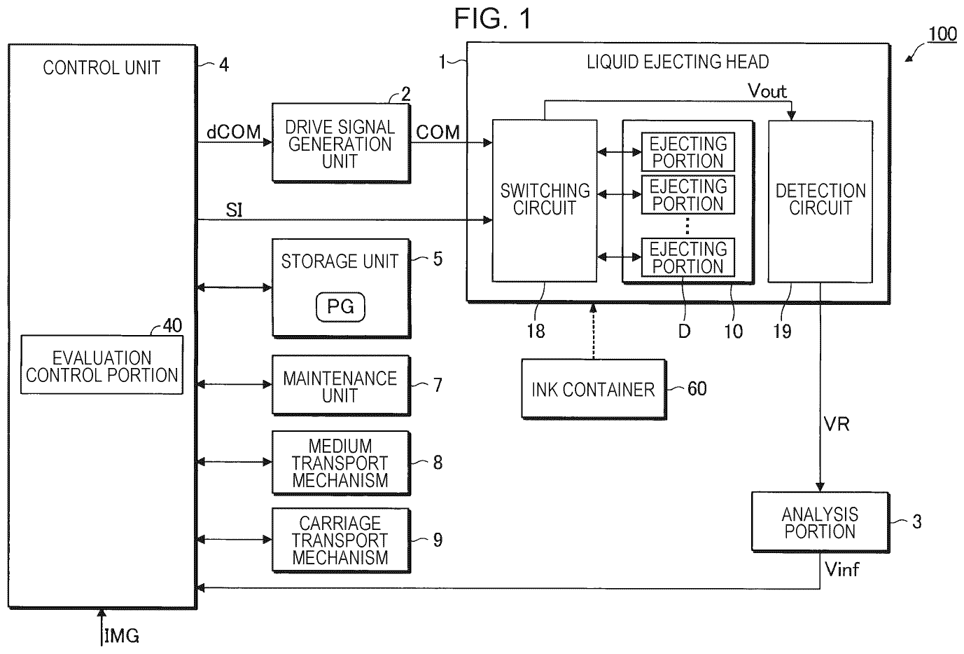

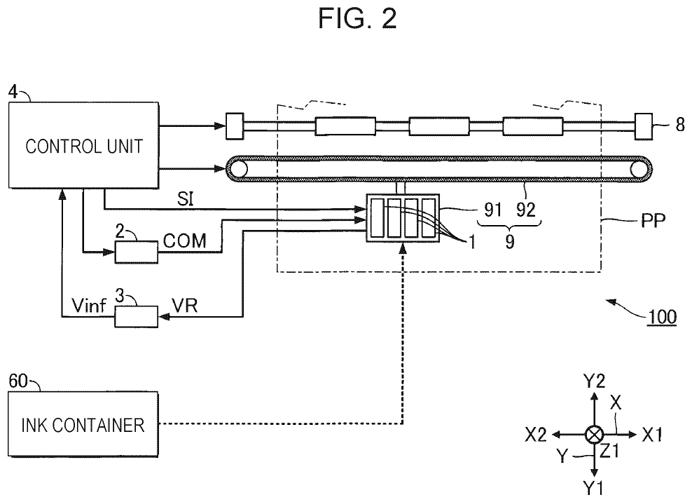

First, an outline of a liquid ejecting apparatus 100 according to the present embodiment will be described with reference to FIG. 1. In the present embodiment, it is assumed that the liquid ejecting apparatus 100 is an ink jet printer that ejects an ink to a medium PP to form an image, as an example. In the present embodiment, a recording paper illustrated in FIG. 2 to be described below is assumed as the medium PP. The ink is an example of a “liquid”.

FIG. 1 is a block diagram illustrating an example of a configuration of the liquid ejecting apparatus 100 according to an embodiment of the present disclosure.

For example, print data IMG indicating an image to be formed by the liquid ejecting apparatus 100 is supplied to the liquid ejecting apparatus 100 from a host computer such as a personal computer or a digital camera. The liquid ejecting apparatus 100 executes a printing process of forming the image indicated by the print data IMG supplied from the host computer on the medium PP.

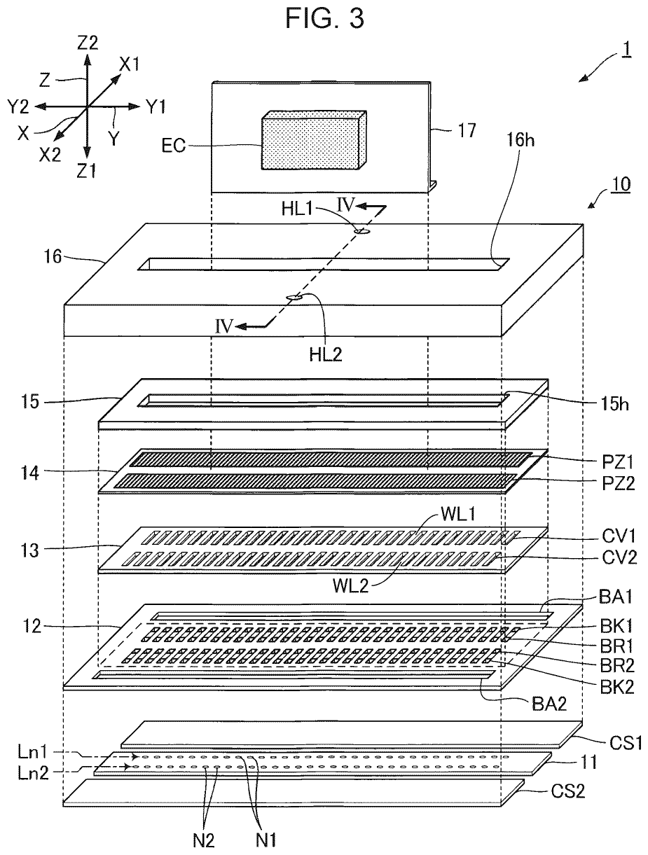

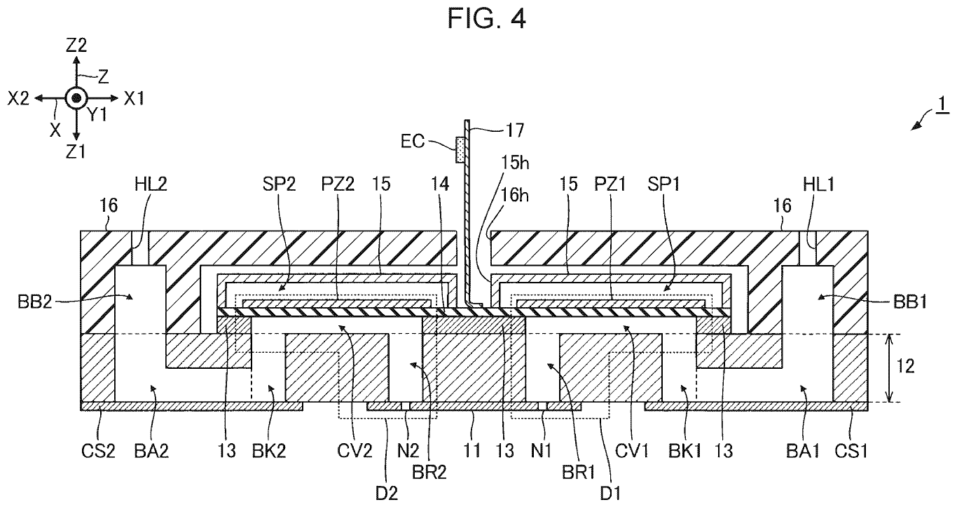

The liquid ejecting apparatus 100 includes a liquid ejecting head 1 provided with an ejecting portion D including a nozzle N that ejects inks, a drive signal generation unit 2 that generates a plurality of drive signals COM for driving the ejecting portion D, and an analysis portion 3 that analyzes residual vibration, which will be described below. The nozzle N will be described below with reference to FIGS. 3 and 4. Further, the liquid ejecting apparatus 100 includes a control unit 4 that controls each portion of the liquid ejecting apparatus 100, and a storage unit 5 that stores various types of information such as the print data IMG and a control program PG of the liquid ejecting apparatus 100. Further, the liquid ejecting apparatus 100 includes a maintenance unit 7 that executes a maintenance process of the liquid ejecting head 1, a medium transport mechanism 8 that transports the medium PP, a carriage transport mechanism 9 that reciprocates a carriage 91, and an ink container 60 that stores the inks. The carriage 91 will be described below with reference to FIG. 2.

In the present embodiment, a case is assumed in which the liquid ejecting head 1 and the drive signal generation unit 2 correspond to each other, and the liquid ejecting head 1 and the analysis portion 3 correspond to each other. For example, the liquid ejecting apparatus 100 may include a plurality of liquid ejecting heads 1, a plurality of drive signal generation units 2, and a plurality of analysis portions 3. In this case, for example, the plurality of drive signal generation units 2 correspond to the plurality of liquid ejecting heads 1 on a one-to-one basis, and the plurality of analysis portions 3 correspond to the plurality of liquid ejecting heads 1 on a one-to-one basis. Alternatively, the liquid ejecting apparatus 100 may include one liquid ejecting head 1, one drive signal generation unit 2 corresponding to the liquid ejecting head 1, and one analysis portion 3 corresponding to the liquid ejecting head 1.

In the present embodiment, a case is assumed in which the liquid ejecting apparatus 100 has four liquid ejecting heads 1 respectively corresponding to four types of inks of cyan, magenta, yellow, and black. That is, in the present embodiment, a case is assumed in which the liquid ejecting apparatus 100 includes four liquid ejecting heads 1, four drive signal generation units 2, and four analysis portions 3. Meanwhile, in the following, for convenience of description, as illustrated in FIG. 1, there may be a case where one liquid ejecting head 1 of the four liquid ejecting heads 1 and one drive signal generation unit 2 corresponding to the one liquid ejecting head 1 are focused on and described.

First, the control unit 4, the drive signal generation unit 2, and the storage unit 5 will be described before the liquid ejecting head 1 is to be described.

The control unit 4 is configured with one or a plurality of central processing units (CPU). The control unit 4 may be configured with a programmable logic device such as a field-programmable gate array (FPGA), instead of the CPU or in addition to the CPU. Further, for example, the control unit 4 generates a signal for controlling an operation of each portion of the liquid ejecting apparatus 100, such as a print signal SI and a waveform designation signal dCOM, by operating according to the control program PG stored in the storage unit 5.

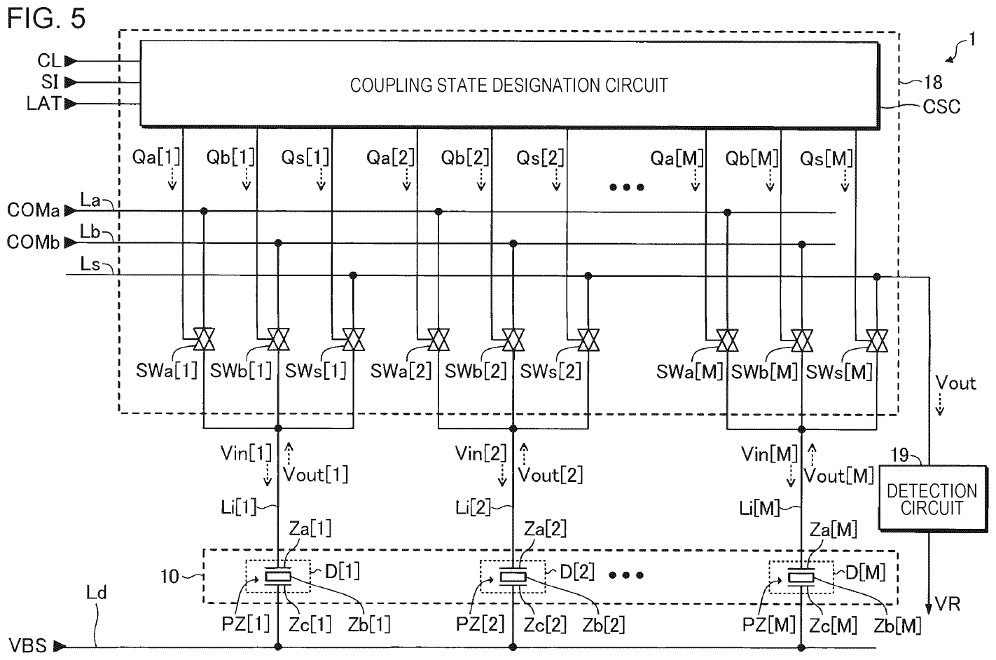

Here, the waveform designation signal dCOM is a digital signal that defines each of waveforms of the plurality of drive signals COM. In addition, each drive signal COM is an analog signal used to drive the ejecting portion D. In the present embodiment, as illustrated in FIG. 5 and the like to be described below, a case is assumed in which the plurality of drive signals COM include drive signals COMa and COMb. The print signal SI is a digital signal for designating a type of operation of the ejecting portion D. Specifically, the print signal SI is a signal for designating the type of operation of the ejecting portion D by designating whether or not to supply each drive signal COM to the ejecting portion D.

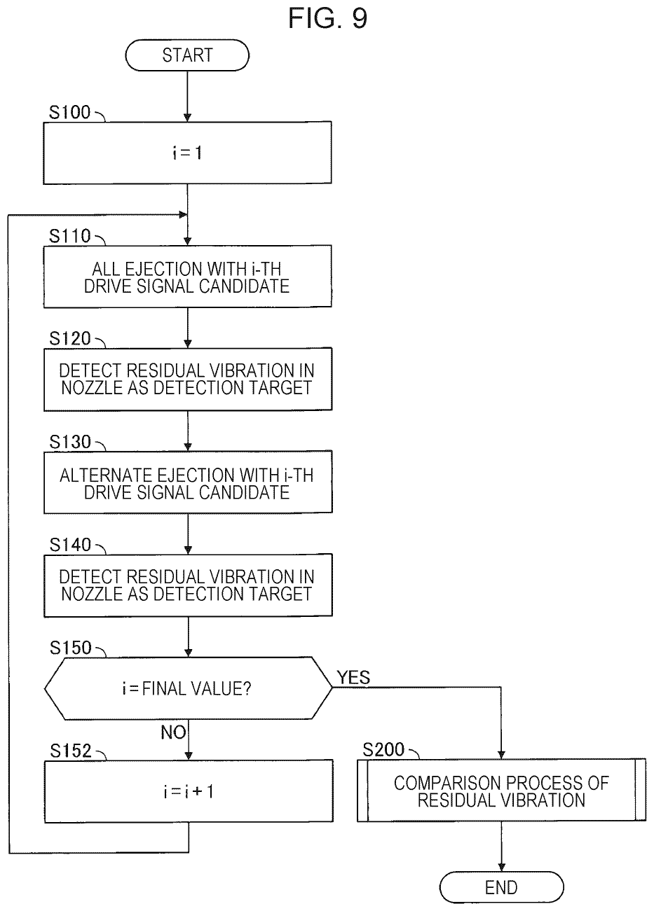

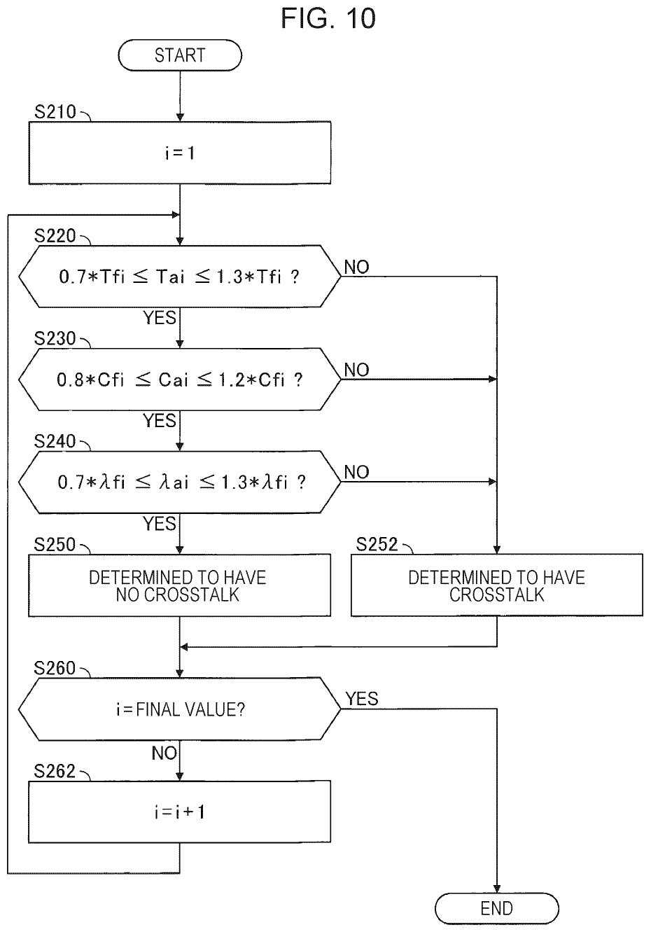

In the present embodiment, the control unit 4 functions as the evaluation control portion 40 by operating according to the control program PG stored in the storage unit 5. The control program PG may be provided from, for example, a head manufacturer that manufactures the liquid ejecting head 1. Details of the operation of the evaluation control portion 40 will be described with reference to FIGS. 9 and 10. For example, the evaluation control portion 40 evaluates crosstalk between a plurality of nozzles N based on residual vibration analyzed by the analysis portion 3. The crosstalk evaluated by the evaluation control portion 40 is, for example, crosstalk in which an ejection characteristic of one nozzle N among the plurality of nozzles N varies depending on an ejection state of the nozzle N around the one nozzle N. The nozzle N around one nozzle N is, for example, the nozzle N adjacent to the one nozzle N. Further, an ejection characteristic of the nozzle N is, for example, an ejection characteristic of an ink by the ejecting portion D.

In this manner, in the present embodiment, so-called structural crosstalk occurring by a structure of the liquid ejecting head 1 such as disposition of the ejecting portion D is evaluated by the evaluation control portion 40. The evaluation control portion 40 is an example of a “control portion”.

The drive signal generation unit 2 includes, for example, a digital analog converter (DAC), and generates the plurality of drive signals COM based on the waveform designation signal dCOM supplied from the control unit 4. For example, each of the plurality of drive signals COM generated by the drive signal generation unit 2 includes a waveform defined by the waveform designation signal dCOM. The drive signal generation unit 2 outputs the plurality of drive signals COM generated based on the waveform designation signal dCOM to a switching circuit 18 included in the liquid ejecting head 1.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 4.

The liquid ejecting head 1 includes the switching circuit 18, a recording head 10, and a detection circuit 19. The detection circuit 19 is an example of a “detection portion”.

The recording head 10 includes M ejecting portions D. In the present embodiment, a case is assumed in which the value M is an even number equal to or more than 2. In the following, among the M ejecting portions D provided in the recording head 10, an m-th ejecting portion D may be referred to as an ejecting portion D[m]. In this case, the variable m is a natural number that satisfies “1≤m≤M”. Further, in the following, when a component, a signal, or the like of the liquid ejecting apparatus 100 corresponds to the ejecting portion D[m] among the M ejecting portions D, the subscript [m] may be added to the reference numerals for representing the component, the signals, or the like.

The switching circuit 18 switches whether or not to supply each drive signal COM to the ejecting portion D[m], based on the print signal SI. In the following, as illustrated in FIG. 5 and the like to be described below, the drive signal COM supplied to the ejecting portion D[m] among the plurality of drive signals COM may be referred to as an individual drive signal Vin[m]. Further, the switching circuit 18 switches whether or not to electrically couple the ejecting portion D[m] and the detection circuit 19 based on the print signal SI. When the ejecting portion D[m] and the detection circuit 19 are electrically coupled to each other, for example, a detection signal Vout[m] detected from the ejecting portion D[m] is supplied to the detection circuit 19 via the switching circuit 18. The detection signal Vout[m] is, for example, an analog signal indicating a waveform of residual vibration, which is vibration remaining in the ejecting portion D[m] after the ejecting portion D[m] is driven by the individual drive signal Vin[m]. Specifically, for example, the detection signal Vout[m] indicates a waveform of residual vibration of a diaphragm 14 after a piezoelectric element PZ[m] is driven. The piezoelectric element PZ and the diaphragm 14 will be described below with reference to FIGS. 3 and 4.

The detection circuit 19 generates a residual vibration signal VR[m] based on the detection signal Vout[m]. For example, the detection circuit 19 amplifies an amplitude of the detection signal Vout[m] or removes a noise component included in the detection signal Vout[m] to shape the detection signal Vout[m] into a waveform appropriate for a process in the analysis portion 3. Therefore, the residual vibration signal VR[m] is generated. For example, the detection circuit 19 may have a configuration including a negative feedback type amplifier for amplifying the detection signal Vout[m], a low-pass filter for attenuating a high-frequency component of the detection signal Vout[m], and a voltage follower that converts an impedance and outputs the residual vibration signal VR[m] having a low impedance.

For example, the residual vibration signal VR[m] generated based on the detection signal Vout[m] is an analog signal indicating a waveform of residual vibration of the diaphragm 14 after the piezoelectric element PZ[m] is driven by the individual drive signal Vin[m]. The detection circuit 19 outputs the residual vibration signal VR[m] generated based on the detection signal Vout[m] to the analysis portion 3. In this manner, the detection circuit 19 detects the residual vibration of the diaphragm 14 caused by driving the piezoelectric element PZ[m] based on the detection signal Vout[m].

The analysis portion 3 includes, for example, an analog to digital converter (ADC), and converts the analog residual vibration signal VR[m] into a digital signal. The analysis portion 3 analyzes, for example, the residual vibration detected by the detection circuit 19 by using the residual vibration signal VR[m] converted into a digital signal. The analysis portion 3 generates residual vibration information Vinf indicating an analysis result of the residual vibration, and outputs the generated residual vibration information Vinf to the control unit 4. The residual vibration information Vinf indicates, for example, a cycle, an amplitude, and a phase of the residual vibration. Meanwhile, the residual vibration information Vinf may indicate a part of the cycle, the amplitude, and the phase of the residual vibration. Alternatively, the residual vibration information Vinf may include information other than the cycle, the amplitude, and the phase of the residual vibration. The evaluation control portion 40 described above evaluates crosstalk between the plurality of nozzles N based on the residual vibration information Vinf, for example. The analysis portion 3 may be included in the control unit 4. For example, the control unit 4 may function as the analysis portion 3 by operating according to the control program PG stored in the storage unit 5. In addition, a part of the analysis portion 3 may be included in the control unit 4. Specifically, the control unit 4 may include a function of analyzing the residual vibration by using the residual vibration signal VR converted into a digital signal, the ADC being provided outside the control unit 4.

Further, in the present embodiment, as described above, the maintenance process is executed by the maintenance unit 7. For example, the maintenance unit 7 executes the maintenance process under the control of the control unit 4. For example, the maintenance process includes flushing processing of discharging inks from the ejecting portion D, wiping processing of wiping off a foreign matter such as an ink adhering to the vicinity of a nozzle N of the ejecting portion D with a wiper, and pumping processing of suctioning the ink in the ejecting portion D with a tube pump or the like.

The maintenance unit 7 includes a discharge ink receiving portion for receiving the discharged ink when the ink in the ejecting portion D is discharged, a wiper for wiping off a foreign matter such as an ink adhering to the vicinity of the nozzle N of the ejecting portion D, and a tube pump for suctioning the ink, air bubbles, and the like in the ejecting portion D, in the flushing processing. The discharge ink receiving portion, the wiper, and the tube pump are not illustrated.

Next, a schematic overall configuration of the liquid ejecting apparatus 100 will be described with reference to FIG. 2.

FIG. 2 is a configuration diagram schematically illustrating the liquid ejecting apparatus 100. In FIG. 2, the ink container 60, the medium transport mechanism 8, and the carriage transport mechanism 9 will be mainly described.

The ink container 60 stores inks. As the ink container 60, for example, a cartridge that can be attached to and detached from the liquid ejecting apparatus 100, a bag-shaped ink pack formed of a flexible film, or an ink tank that can be replenished with inks can be adopted. A type of the ink stored in the ink container 60 is not particularly limited, and is optional. In the present embodiment, as described above, a case is assumed in which the liquid ejecting apparatus 100 includes four liquid ejecting heads 1 respectively corresponding to four types of inks of cyan, magenta, yellow, and black. Therefore, in the present embodiment, the ink container 60 stores four types of inks of cyan, magenta, yellow, and black. Further, the ink container 60 supplies the stored ink to the liquid ejecting head 1.

The medium transport mechanism 8 transports the medium PP in a Y1 direction along a Y-axis under the control of the control unit 4. Hereinafter, the Y1 direction and a Y2 direction opposite to the Y1 direction are collectively referred to as a Y-axis direction. In addition, hereinafter, an X1 direction along an X-axis that intersects the Y-axis and an X2 direction opposite to the X1 direction are collectively referred to as an X-axis direction. In addition, hereinafter, a Z1 direction along a Z-axis that intersects the X-axis and the Y-axis and a Z2 direction opposite to the Z1 direction are collectively referred to as a Z-axis direction. In the present embodiment, as an example, description will be performed by assuming that the X-axis, the Y-axis, and the Z-axis are orthogonal to each other. Meanwhile, the present disclosure is not limited to such an aspect. The X-axis, the Y-axis, and the Z-axis may intersect each other.

The carriage transport mechanism 9 reciprocates the plurality of liquid ejecting heads 1 in the X1 direction and the X2 direction under the control of the control unit 4. As illustrated in FIG. 2, the carriage transport mechanism 9 includes the substantially box-shaped carriage 91 that accommodates the plurality of liquid ejecting heads 1, and an endless belt 92 to which the carriage 91 is fixed. The ink container 60 may be stored in the carriage 91 together with the liquid ejecting head 1.

The liquid ejecting head 1 is driven by the drive signal COM under the control of the print signal SI, and ejects the ink in the Z1 direction from some or all of a plurality of nozzles N provided in the liquid ejecting head 1. That is, the liquid ejecting head 1 forms a desired image on a surface of the medium PP by ejecting the ink from the some or all of the plurality of nozzles N in conjunction with transport of the medium PP by the medium transport mechanism 8 and a reciprocating motion of the liquid ejecting head 1 by the carriage transport mechanism 9 and landing the ejected ink on the surface of the medium PP. In the present embodiment, as described above, the Z1 direction is a direction in which an ink is ejected from the nozzle N.

Next, a schematic structure of the liquid ejecting head 1 will be described with reference to FIGS. 3 and 4.

FIG. 3 is an exploded perspective view of the liquid ejecting head 1. FIG. 4 is a cross-sectional diagram taken along a line IV-IV illustrated in FIG. 3. A cross section of the line IV-IV is parallel to the XZ plane and passes through inlets HL1 and HL2, which will be described below. In FIGS. 3 and 4, in order to distinguish two nozzle rows Ln from each other, which will be described below, an end of a reference sign of a nozzle row Ln is added with a number “1” or “2”. In addition, in FIGS. 3 and 4, in order to facilitate the description, the number “1” is added to the end of the reference sign of the nozzle N included in a nozzle row Ln1, and the number “2” is added to the end of the reference sign of the nozzle N included in a nozzle row Ln2.

As illustrated in FIGS. 3 and 4, the liquid ejecting head 1 includes a nozzle substrate 11, compliance sheets CS1 and CS2, a communication plate 12, a pressure chamber substrate 13, a diaphragm 14, a sealing substrate 15, a flow path forming substrate 16, and a wiring substrate 17 at which an electronic component EC is mounted. The electronic component EC includes, for example, an electric circuit such as the switching circuit 18 and the detection circuit 19. For example, the recording head 10 is electrically coupled to the switching circuit 18, the detection circuit 19, and the like via the wiring substrate 17.

As illustrated in FIG. 3, the recording head 10 includes, for example, the nozzle substrate 11, the compliance sheets CS1 and CS2, the communication plate 12, the pressure chamber substrate 13, the diaphragm 14, the sealing substrate 15, and the flow path forming substrate 16.

The nozzle substrate 11 is a plate-shaped member elongated in the Y-axis direction and extending substantially parallel to an XY plane. Here, “substantially parallel” is a concept that includes not only a case of being completely parallel but also a case of being considered to be parallel when an error is considered. In the present embodiment, “substantially parallel” is a concept that includes a case where it can be regarded as parallel when an error of approximately 10% is considered. The “substantially vertical” described below is also a concept that includes a case where it is considered to be vertical when an error is taken into consideration, in addition to a case where it is completely vertical, as in the case of the “substantially parallel”. The nozzle substrate 11 is manufactured, for example, by processing a silicon single crystal substrate using a semiconductor manufacturing technology such as etching, and any known material and manufacturing method may be adopted to manufacture the nozzle substrate 11.

M nozzles N are formed at the nozzle substrate 11. Here, the nozzle N is a through-hole provided in the nozzle substrate 11. In the present embodiment, a case is assumed in which the plurality of nozzles N formed in the nozzle substrate 11 include a plurality of nozzles N1 arranged to extend in the Y-axis direction, and a plurality of nozzles N2 arranged to extend in the Y-axis direction at a position in the X2 direction when viewed from the plurality of nozzles N1. In the following, the plurality of nozzles N1 arranged to extend in the Y-axis direction are referred to as the nozzle row Ln1, and the plurality of nozzles N2 arranged to extend in the Y-axis direction are referred to as the nozzle row Ln2. For example, the number of nozzles N included in each of the nozzle rows LN1 and Ln2 is half the value M. In the following, the nozzle row Ln1 and the nozzle row Ln2 may be collectively referred to as a nozzle row Ln. In addition, in FIGS. 3 and 4, in order to facilitate the description, in the liquid ejecting head 1, a number “1” is added to an end of a reference sign of a component corresponding to the nozzle row Ln1, and a number “2” is added to an end of a reference sign of a component corresponding to the nozzle row Ln2.

As illustrated in FIGS. 3 and 4, a communication plate 12 is provided at a position in the Z2 direction when viewed from a nozzle substrate 11. The communication plate 12 is a plate-shaped member elongated in the Y-axis direction and extending substantially parallel to the XY plane. The communication plate 12 is manufactured, for example, by processing a silicon single crystal substrate using semiconductor manufacturing technology, and any known material and manufacturing method may be adopted to manufacture the communication plate 12.

A flow path for inks is formed in the communication plate 12. Specifically, the communication plate 12 is formed with one supply flow path BA1 provided to extend in the Y-axis direction, and one supply flow path BA2 provided to extend in the Y-axis direction at a position in the X2 direction when viewed from the supply flow path BA1. In addition, the communication plate 12 is formed with a plurality of coupling flow paths BK1 corresponding to the plurality of nozzles N1, a plurality of coupling flow paths BK2 corresponding to the plurality of nozzles N2, a plurality of communication flow paths BR1 corresponding to the plurality of nozzles N1, and a plurality of communication flow paths BR2 corresponding to the plurality of nozzles N2.

As illustrated in FIG. 4, the coupling flow path BK1 is provided to communicate with the supply flow path BA1 and extend in the Z-axis direction at a position in the X2 direction when viewed from the supply flow path BA1. The communication flow path BR1 is provided to extend in the Z-axis direction at a position in the X2 direction when viewed from the coupling flow path BK1. The communication flow path BR1 communicates with the nozzle N1 corresponding to the communication flow path BR1. The coupling flow path BK2 is provided to communicate with the supply flow path BA2 and extend in the Z-axis direction at a position in the X1 direction when viewed from the supply flow path BA2. The communication flow path BR2 is provided to extend in the Z-axis direction at a position, which is a position in the X1 direction when viewed from the coupling flow path BK2 and in the X2 direction when viewed from the communication flow path BR1. The communication flow path BR2 communicates with the nozzle N2 corresponding to the communication flow path BR2.

The supply flow paths BA1 and BA2 are also referred to as a supply flow path BA without particular distinction, the coupling flow paths BK1 and BK2 are also referred to as a coupling flow path BK without particular distinction, and the communication flow paths BR1 and BR2 are also referred to as a communication flow path BR without particular distinction.

As illustrated in FIGS. 3 and 4, the pressure chamber substrate 13 is provided at a position in the Z2 direction when viewed from the communication plate 12. The pressure chamber substrate 13 is a plate-shaped member elongated in the Y-axis direction and extending substantially parallel to the XY plane. The pressure chamber substrate 13 is manufactured, for example, by processing a silicon single crystal substrate using semiconductor manufacturing technology, and any known material and manufacturing method may be adopted to manufacture the pressure chamber substrate 13.

A flow path for inks is formed in the pressure chamber substrate 13. Specifically, the pressure chamber substrate 13 is formed with a plurality of pressure chambers CV1 corresponding to the plurality of nozzles N1 and a plurality of pressure chambers CV2 corresponding to the plurality of nozzles N2. For example, as illustrated in FIG. 3, the plurality of pressure chambers CV1 are partitioned by a partition wall WL1 of the pressure chamber substrate 13 and are arranged in the Y-axis direction. Further, the plurality of pressure chambers CV2 are partitioned by a partition wall WL2 of the pressure chamber substrate 13, and are arranged in the Y-axis direction at a position in the X2 direction when viewed from the plurality of pressure chambers CV1. As illustrated in FIG. 4, the pressure chamber CV1 is provided to couple an end portion of the coupling flow path BK1 in the X2 direction and an end portion of the communication flow path BR1 in the X1 direction when viewed in the Z-axis direction, and extend in the X-axis direction. When viewed in the Z-axis direction, the pressure chamber CV2 is provided to couple an end portion of the coupling flow path BK2 in the X1 direction and an end portion of the communication flow path BR2 in the X2 direction, and extend in the X-axis direction. The pressure chambers CV1 and CV2 are also referred to as a pressure chamber CV without particular distinction, and the partition walls WL1 and WL2 are also referred to as a partition wall WL without particular distinction.

As illustrated in FIGS. 3 and 4, the diaphragm 14 is provided at a position in the Z2 direction when viewed from the pressure chamber substrate 13. The diaphragm 14 is a plate-shaped member elongated in the Y-axis direction and extending substantially parallel to the XY plane, and is a member that can vibrate elastically. In the present embodiment, the diaphragm 14 has, for example, an elastic layer made of silicon oxide and an insulating layer made of zirconium oxide provided at a position in the Z2 direction when viewed from the elastic layer. That is, in the present embodiment, a surface of the diaphragm 14 in the Z2 direction is formed with a non-conductive member. Here, a surface of an element A in a first direction is a surface of the element A, which is substantially vertical to the first direction among surfaces of the element A, and is a surface which is visible when the element A is viewed in the first direction from a second direction. The second direction is a direction opposite to the first direction. The elastic layer of the diaphragm 14 is not limited to the elastic layer made of silicon oxide. In the same manner, the insulating layer of the diaphragm 14 is not limited to the insulating layer made of zirconium oxide.

As illustrated in FIGS. 3 and 4, a plurality of piezoelectric elements PZ1 corresponding to the plurality of pressure chambers CV1 and a plurality of piezoelectric elements PZ2 corresponding to the plurality of pressure chambers CV2 are provided at a position in the Z2 direction when viewed from the diaphragm 14. The piezoelectric elements PZ1 and PZ2 are also referred to as a piezoelectric element PZ without particular distinction. The piezoelectric element PZ is driven by the drive signal COM being supplied.

Although not illustrated in FIGS. 3 and 4, the piezoelectric element PZ has a common electrode Zc to which a predetermined bias potential VBS is supplied, an individual electrode Za to which the individual drive signal Vin is supplied, and a piezoelectric body Zb provided between the individual electrode Za and the common electrode Zc, as illustrated in FIG. 5. For example, the individual electrode Za, the piezoelectric body Zb, and the common electrode Zc are provided in this order along the Z2 direction on the surface of the diaphragm 14 in the Z2 direction. Here, an expression “an element B is formed at the surface of the element A” in the present specification is not intended to limit the configuration to a configuration in which the element A and the element B are in direct contact with each other. That is, a configuration in which an element C is formed at the surface of the element A and the element B is formed at a surface of the element C is also included in the concept of “the element B is formed at the surface of the element A” insofar as the element A and the element B overlap at least in part in plan view. In the present embodiment, the common electrode Zc is a so-called upper electrode, and the individual electrode Za is a so-called lower electrode, and the common electrode Zc may be a lower electrode and the individual electrode Za may be an upper electrode.

The piezoelectric element PZ is a passive element that is deformed in response to a potential change of the drive signal COM supplied to the individual electrode Za as the individual drive signal Vin. In other words, the piezoelectric element PZ is an example of an energy conversion element that converts the electric energy of the drive signal COM into kinetic energy. Specifically, the piezoelectric element PZ is driven and deformed in response to a potential change of the drive signal COM.

As illustrated in FIGS. 3 and 4, since the piezoelectric element PZ is provided on the surface of the diaphragm 14 in the Z2 direction, the diaphragm 14 vibrates in conjunction with the deformation of the piezoelectric element PZ. That is, the diaphragm 14 vibrates by driving the piezoelectric element PZ. When the diaphragm 14 vibrates, a pressure in the pressure chamber CV fluctuates. Then, the pressure inside the pressure chamber CV fluctuates, and an ink with which an inside of the pressure chamber CV is filled is ejected from the nozzle N via the communication flow path BR. In this manner, the pressure chamber CV is filled with the ink, and a pressure for ejecting the ink from the nozzle N is applied by the vibration of the diaphragm 14. In addition, the vibration remaining in the ejecting portion D[m] described in FIG. 1 can be regarded as, for example, vibration remaining in the ink in the pressure chamber CV of the ejecting portion D.

As illustrated in FIGS. 3 and 4, the sealing substrate 15 for protecting the plurality of piezoelectric elements PZ1 and the plurality of piezoelectric elements PZ2 is provided at a position in the Z2 direction when viewed from the pressure chamber substrate 13. The sealing substrate 15 is a plate-shaped member elongated in the Y-axis direction and extending substantially parallel to the XY plane. The sealing substrate 15 is manufactured, for example, by processing a silicon single crystal substrate using semiconductor manufacturing technology, and any known material and manufacturing method may be adopted to manufacture the sealing substrate 15.

As illustrated in FIG. 4, a surface of the sealing substrate 15 in the Z1 direction is provided with a recess portion for covering the plurality of piezoelectric elements PZ1 and a recess portion for covering the plurality of piezoelectric elements PZ2. In the following, a sealing space covering the plurality of piezoelectric elements PZ1 and formed between the diaphragm 14 and the sealing substrate 15 is referred to as a sealing space SP1, and a sealing space covering the plurality of piezoelectric elements PZ2 and formed between the diaphragm 14 and the sealing substrate 15 is referred to as a sealing space SP2. Further, the sealing spaces SP1 and SP2 are also referred to as a sealing space SP without particular distinction. The sealing space SP is a space for sealing the piezoelectric element PZ and preventing the piezoelectric element PZ from deteriorating due to an influence of moisture or the like.

The sealing substrate 15 is provided with a through-hole 15h. The through-hole 15h is a hole that is located between the sealing space SP1 and the sealing space SP2 when the sealing substrate 15 is viewed in the Z1 direction, and penetrates from the surface of the sealing substrate 15 in the Z1 direction to the surface of the sealing substrate 15 in the Z2 direction. The wiring substrate 17 is inserted into the through-hole 15h.

As illustrated in FIGS. 3 and 4, the flow path forming substrate 16 is provided at a position in the Z2 direction when viewed from the communication plate 12. The flow path forming substrate 16 is a plate-shaped member elongated in the Y-axis direction and extending substantially parallel to the XY plane. The flow path forming substrate 16 is formed by, for example, injection molding of a resin material, and any known material and manufacturing method may be adopted to manufacture the flow path forming substrate 16.

As illustrated in FIG. 4, a flow path for inks is formed in the flow path forming substrate 16. Specifically, the flow path forming substrate 16 is formed with one supply flow path BB1 and one supply flow path BB2. Among these, the supply flow path BB1 is provided to communicate with the supply flow path BA1 and extend in the Y-axis direction at a position in the Z2 direction when viewed from the supply flow path BA1. The supply flow path BB2 is provided to communicate with the supply flow path BA2 and extend in the Y-axis direction at a position, which is a position in the Z2 direction when viewed from the supply flow path BA2 and in the X2 direction when viewed from the supply flow path BB1. The supply flow paths BB1 and BB2 are also referred to as a supply flow path BB without particular distinction.

The flow path forming substrate 16 is provided with the inlet HL1 communicating with the supply flow path BB1 and the inlet HL2 communicating with the supply flow path BB2. The ink is supplied from the ink container 60 to the supply flow path BB1 via the inlet HL1. The ink supplied from the ink container 60 to the supply flow path BB1 via the inlet HL1 flows into the supply flow path BAL. The pressure chamber CV1 is filled with a part of the ink flowing into the supply flow path BA1, via the coupling flow path BK1. When the piezoelectric element PZ1 is driven by the drive signal COM, the part of the ink filled in the pressure chamber CV1 is ejected from the nozzle N1 via the communication flow path BR1.

In addition, the ink is supplied from the ink container 60 to the supply flow path BB2 via the inlet HL2. The ink supplied from the ink container 60 to the supply flow path BB2 via the inlet HL2 flows into the supply flow path BA2. The pressure chamber CV2 is filled with a part of the ink flowing into the supply flow path BA2, via the coupling flow path BK2. When the piezoelectric element PZ2 is driven by the drive signal COM, the part of the ink filled in the pressure chamber CV2 is ejected from the nozzle N2 via the communication flow path BR2.

The flow path forming substrate 16 is provided with a through-hole 16h. The through-hole 16h is a hole that is located between the supply flow path BB1 and the supply flow path BB2 when the flow path forming substrate 16 is viewed in the Z1 direction, and penetrates from a surface of the flow path forming substrate 16 in the Z1 direction to the surface of the flow path forming substrate 16 in the Z2 direction. The wiring substrate 17 is inserted into the through-hole 16h.

As illustrated in FIGS. 3 and 4, the wiring substrate 17 is mounted on a surface of the diaphragm 14 in the Z2 direction. The wiring substrate 17 is a component for electrically coupling the liquid ejecting head 1 to the control unit 4. As the wiring substrate 17, for example, a flexible wiring substrate such as a flexible printed circuit (FPC) or a flexible flat cable (FFC) is preferably adopted. As described above, the electronic component EC including the switching circuit 18, the detection circuit 19, and the like is mounted at the wiring substrate 17.

As illustrated in FIGS. 3 and 4, the compliance sheet CS1 is provided to close the supply flow path BA1 and the coupling flow path BK1, and the compliance sheet CS2 is provided to close the supply flow path BA2 and the coupling flow path BK2, at a position in the Z1 direction when viewed from the communication plate 12. The compliance sheets CS1 and CS2 are also referred to as a compliance sheet CS without particular distinction. The compliance sheet CS is a plate-shaped member elongated in the Y-axis direction and extending substantially parallel to the XY plane. The compliance sheet CS is formed with an elastic material, and absorbs the pressure fluctuation of the ink inside the supply flow path BA and the coupling flow path BK.

Here, as illustrated in FIG. 4, the ejecting portion D1 includes the piezoelectric element PZ1, the pressure chamber CV1, the nozzle N1 communicating with the pressure chamber CV1, and a portion of the diaphragm 14 that is in contact with the piezoelectric element PZ1. In the same manner, the ejecting portion D2 includes the piezoelectric element PZ2, the pressure chamber CV2, the nozzle N2 communicating with the pressure chamber CV2, and a portion of the diaphragm 14 that is in contact with the piezoelectric element PZ2. The ejecting portions D1 and D2 are also referred to as an ejecting portion D without particular distinction. In addition, in the following, between a first element and a second element included in one ejecting portion D, the second element is also referred to as the second element corresponding to the first element. Specifically, for example, the piezoelectric element PZ included in the ejecting portion D having one nozzle N is also referred to as the piezoelectric element PZ corresponding to one nozzle N.

In addition, although not illustrated, the liquid ejecting head 1 has a cap for sealing a nozzle surface, which is a surface of the nozzle substrate 11 in the Z1 direction. The cap seals the nozzle surface of the nozzle substrate 11 at which the nozzle N is formed in a period in which the ink is not ejected from the nozzle N.

Next, an outline of the liquid ejecting head 1 will be described with reference to FIG. 5.

FIG. 5 is a block diagram illustrating an example of a configuration of the liquid ejecting head 1.

As described in FIG. 1, the liquid ejecting head 1 includes the recording head 10, the switching circuit 18, and the detection circuit 19. Further, the liquid ejecting head 1 has a wiring La to which the drive signal COMa is supplied from the drive signal generation unit 2 and a wiring Lb to which the drive signal COMb is supplied from the drive signal generation unit 2. Further, the liquid ejecting head 1 includes a wiring Ls that supplies the detection signal Vout to the detection circuit 19, a wiring Li[m] that supplies the individual drive signal Vin[m] to the ejecting portion D[m], and a wiring Ld to which the bias potential VBS is supplied.

The switching circuit 18 includes M switches SWa[1] to SWa[M] corresponding to the M ejecting portions D[1] to D[M] on a one-to-one basis, M switches SWb[1] to SWb[M] corresponding to the M ejecting portions D[1] to D[M] on a one-to-one basis, and M switches SWs[1] to SWs[M] corresponding to the M ejecting portions D[1] to D[M] on a one-to-one basis.

Further, the switching circuit 18 includes a coupling state designation circuit CSC. The coupling state designation circuit CSC designates a coupling state of each of the M switches SWa, the M switches SWb, and the M switches SWs. For example, the coupling state designation circuit CSC generates coupling state designation signals Qa[m], Qb[m], and Qs[m], based on at least some signals of the print signal SI and a latch signal LAT supplied from the control unit 4.

For example, the coupling state designation signal Qa[m] is a signal for designating ON or OFF of the switch SWa[m], and the coupling state designation signal Qb[m] is a signal for designating ON or OFF of the switch SWb[m]. Further, the coupling state designation signal Qs[m] is a signal for designating ON or OFF of the switch SWs[m].

The switch SWa[m] switches conduction and non-conduction between the wiring La and the individual electrode Za[m] of the piezoelectric element PZ[m] provided in the ejecting portion D[m], based on the coupling state designation signal Qa[m]. That is, the switch SWa[m] switches conduction and non-conduction between the wiring La and the wiring Li[m] coupled to the individual electrode Za[m], based on the coupling state designation signal Qa[m]. In the present embodiment, the switch SWa[m] is turned on when the coupling state designation signal Qa[m] is at a high level, and is turned off when the coupling state designation signal Qa[m] is at a low level. When the switch SWa[m] is turned on, the drive signal COMa supplied to the wiring La is supplied to the individual electrode Za[m] of the ejecting portion D[m] as the individual drive signal Vin[m] via the wiring Li[m].

The switch SWb[m] switches conduction and non-conduction between the wiring Lb and the individual electrode Za[m] of the piezoelectric element PZ[m] provided in the ejecting portion D[m], based on the coupling state designation signal Qb[m]. That is, the switch SWb[m] switches conduction and non-conduction between the wiring Lb and the wiring Li[m] coupled to the individual electrode Za[m], based on the coupling state designation signal Qb[m]. In the present embodiment, the switch SWb[m] is turned on when the coupling state designation signal Qb[m] is at a high level, and is turned off when the coupling state designation signal Qb[m] is at a low level. When the switch SWb[m] is turned on, the drive signal COMb supplied to the wiring Lb is supplied to the individual electrode Za[m] of the ejecting portion D[m] as the individual drive signal Vin[m] via the wiring Li[m].

The switch SWs[m] switches conduction and non-conduction between the wiring Ls and the individual electrode Za[m] of the piezoelectric element PZ[m] provided in the ejecting portion D[m], based on the coupling state designation signal Qs[m]. That is, the switch SWs[m] switches conduction and non-conduction between the wiring Ls and the wiring Li[m] coupled to the individual electrode Za[m], based on the coupling state designation signal Qs[m]. In the present embodiment, the switch SWs[m] is turned on when the coupling state designation signal Qs[m] is at a high level, and is turned off when the coupling state designation signal Qs[m] is at a low level.

For example, the coupling state designation signal Qs[m] becomes a high level when the residual vibration of the ejecting portion D[m] is detected. In the following, the ejecting portion D in which the residual vibration is detected may be referred to as the ejecting portion D as a detection target. In addition, in the following, the nozzle N included in the ejecting portion D, which is a detection target, may be referred to as the nozzle N as a detection target. When the switch SWs[m] is turned on, the detection signal Vout[m] indicating a potential of the individual electrode Za[m] of the piezoelectric element PZ[m] included in the ejecting portion D[m] as a detection target is supplied to the detection circuit 19 via the wiring Li[m] and the wiring Ls. The detection circuit 19 generates the residual vibration signal VR[m] based on the detection signal Vout[m].

As described above, the individual drive signal Vin[m] is a signal supplied to the piezoelectric element PZ[m] of the ejecting portion D[m] via the switch SWa[m] or SWb[m], among the drive signals COMa and COMb. In the present embodiment, a case is assumed in which the drive signal COMa is the drive signal COM for ejecting an ink from the nozzle N, and the drive signal COMb is the drive signal COM for not ejecting the ink from the nozzle N. Therefore, in the present embodiment, the drive signal COMa is an example of an “ejection signal”, and the drive signal COMb is an example of a “holding signal”.

Here, in the liquid ejecting head 1 having the plurality of nozzles N, it is preferable to prevent a variation in ejection characteristic of the nozzle N due to structural crosstalk. In the present embodiment, the occurrence of crosstalk is prevented by adjusting a potential difference between the individual electrode Za and the common electrode Zc of the piezoelectric element PZ corresponding to the nozzle N that does not eject the ink. Hereinafter, the nozzle N that does not eject the ink is also referred to as the non-ejection nozzle N. In the present embodiment, for example, occurrence of crosstalk is prevented by adjusting a potential of the drive signal COMb supplied to the piezoelectric element PZ corresponding to the non-ejection nozzle N. In the present embodiment, a case is assumed in which a potential equal to the potential of the drive signal COMb is set as a reference potential of the drive signal COMa, and the reference potential of the drive signal COMa may be a potential different from the potential of the drive signal COMb.

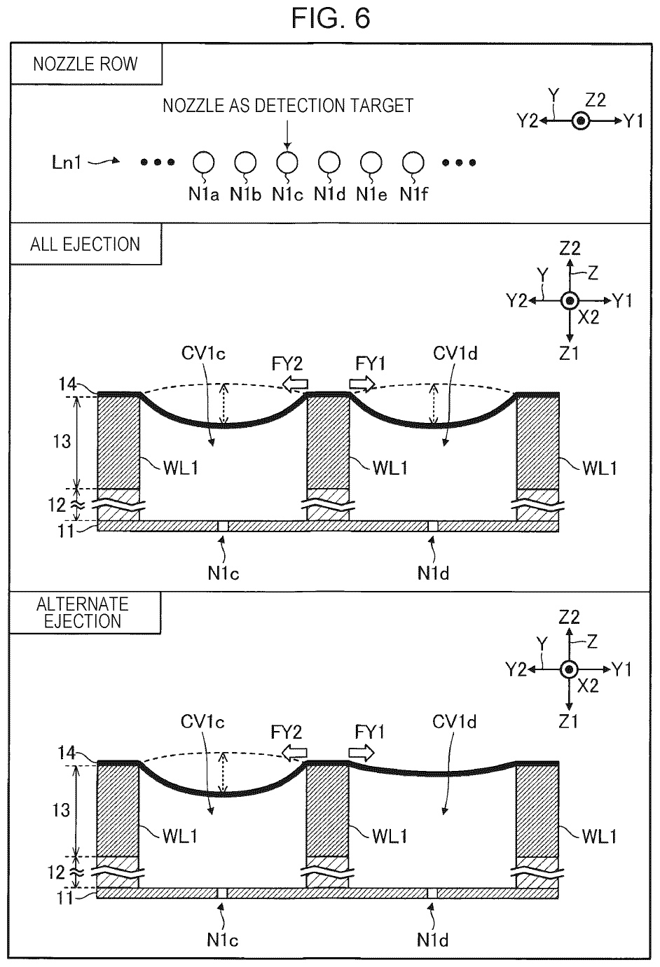

Next, crosstalk will be briefly described with reference to FIG. 6. The crosstalk in the present embodiment refers to so-called structural crosstalk in which a characteristic of ejection from the nozzle N communicating with a target pressure chamber varies depending on a drive state of a pressure chamber close to (in particular, adjacent to) the target pressure chamber.

FIG. 6 is an explanatory diagram describing crosstalk. In FIG. 6, the crosstalk will be described with reference to the plurality of nozzles N1 included in the nozzle row Ln1. In FIG. 6, in order to facilitate the description, alphabets “a”, “b”, “c”, “d”, “e”, or “f” are added to an end of the reference numerals of the plurality of nozzles N1. In addition, the alphabet “c” is added to an end of the reference sign of the pressure chamber CV1 corresponding to a nozzle N1c, and the alphabet “d” is added to an end of the reference sign of the pressure chamber CV1 corresponding to a nozzle N1d.

In FIG. 6, a case is assumed in which the nozzle N1c is the nozzle N as a detection target as illustrated in a “nozzle row” in FIG. 6. That is, in FIG. 6, one factor that an ejection characteristic of the nozzle N1c varies due to an ejection state of the nozzle N1d adjacent to the nozzle N1c is briefly described. The nozzle N1c is an example of a “first nozzle”, the nozzle N1d is an example of a “second nozzle”, and a nozzle N1b is an example of a “third nozzle”. In addition, the piezoelectric element PZ corresponding to the nozzle N1c is an example of a “first piezoelectric element”, the piezoelectric element PZ corresponding to the nozzle N1d is an example of a “second piezoelectric element”, and the piezoelectric element PZ corresponding to the nozzle N1b is an example of a “third piezoelectric element”.

In FIG. 6, the diaphragm 14 and the like when all the plurality of nozzles N1 included in the nozzle row Ln1 are driven to eject ink are schematically illustrated in “all ejection”. Hereinafter, driving in which inks are ejected from all of the plurality of nozzles N is also referred to as the “all ejection”. Forces FY1 and FY2 in FIG. 6 respectively indicate forces in the Y1 direction and the Y2 direction applied to a portion of the diaphragm 14, which is coupled to the partition wall WL1 between a pressure chamber CV1c and a pressure chamber CV1d.

In addition, in “alternate ejection” of FIG. 6, the diaphragm 14 and the like when only the even-numbered nozzles N1 or only the odd-numbered nozzles N1 among the plurality of nozzles N1 included in the nozzle row Ln1 are driven to eject the inks are schematically illustrated. That is, in the “alternate ejection” in FIG. 6, the diaphragm 14 and the like when the nozzles N1a, N1c, and N1e are driven to eject the inks and the nozzles N1b, N1d, and N1f are driven not to eject the inks are schematically illustrated. In the following, driving in which the inks are ejected only from the even-numbered nozzles N or only from the odd-numbered nozzles N among the plurality of nozzles N arranged along the Y-axis direction is also referred to as the “alternate ejection”.

In the all ejection, the piezoelectric elements PZ are driven in the same manner in the nozzle N1c, which is a detection target, and the nozzle N1d adjacent to the nozzle N1c. Therefore, it is considered that the force FY1 is the same force as the force FY2.

On the other hand, in the alternate ejection, the piezoelectric element PZ corresponding to the nozzle N1d is driven such that the ink is not ejected from the nozzle N1d. Therefore, the force FY1 at a time of the alternate ejection is considered to fluctuate from the force FY1 at a time of the all ejection. Therefore, it is considered that a difference between the force FY1 and the force FY2 differs between the all ejection and the alternate ejection. It is considered that a cause of occurrence of vibration of the diaphragm 14 and the like is changed and the ejection characteristic of the nozzle N1c is changed, due to the fluctuation of the difference between the force FY1 and the force FY2.

In this manner, the difference between the force FY1 and the force FY2 varies between the all ejection and the alternate ejection, which is considered to be one of the causes of the occurrence of crosstalk. The force FY1 during the alternate ejection is controlled, for example, by adjusting a potential difference between the individual electrode Za and the common electrode Zc of the piezoelectric element PZ corresponding to the non-ejection nozzle N. Therefore, in the present embodiment, by adjusting the potential difference between the individual electrode Za and the common electrode Zc of the piezoelectric element PZ corresponding to the non-ejection nozzle N, the fluctuation of the difference between the force FY1 and the force FY2 during the alternate ejection, from the difference between the force FY1 and the force FY2 during the all ejection is prevented. As a result, in the present embodiment, the occurrence of crosstalk is prevented.

Here, the variation in forces FY1 and FY2 applied to the diaphragm 14 is described as the cause of the occurrence of the structural crosstalk, and there are other influences. For example, in the all ejection, when the pressure chamber CV1c is contracted at a time of ejection, a force is applied to the partition wall WL to push the partition wall WL to an outside by the internal pressure. Meanwhile, the force derived from the internal pressure applied to the partition wall WL is actually canceled since the same force is applied to the pressure chamber CV1d. On the other hand, in the alternate ejection, since the pressure chamber CV1d is not contracted and the internal pressure is not increased, when the pressure chamber CV1c is contracted, the partition wall WL may be slightly inclined toward the pressure chamber CV1d side due to the internal pressure. In this case, the internal pressure that contributes to the ejection of the liquid is impaired, so that a variation in ejection characteristic occurs, such as the slightly reduced ejection amount.

In this manner, structural crosstalk occurs by being caused by a plurality of factors in a complex manner. Meanwhile, in any case, a “variation in ejection characteristic of a target pressure chamber according to a drive state of an adjacent pressure chamber” is the structural crosstalk, and in the present embodiment, the potential of the drive signal COMb is adjusted to release the structural crosstalk. In order to prevent occurrence of crosstalk, an element other than the potential of the drive signal COMb may be adjusted.

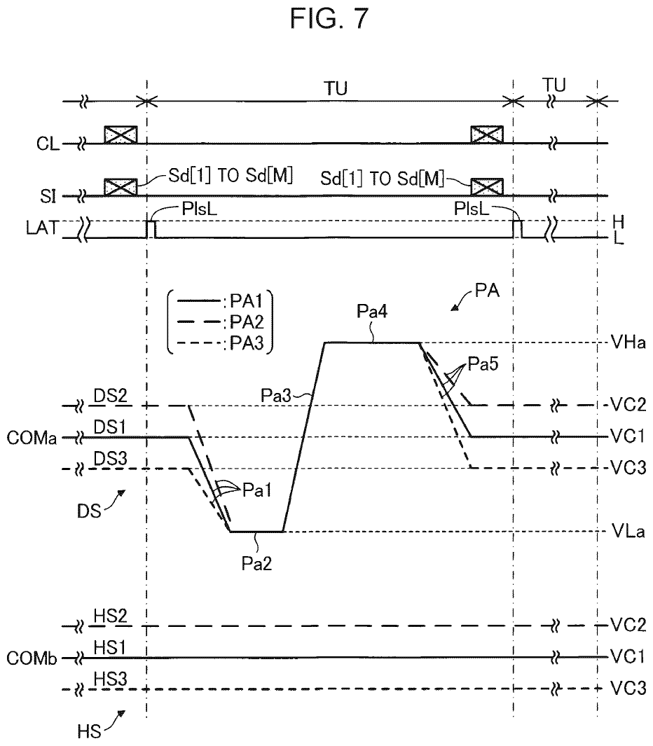

Next, an operation of the liquid ejecting apparatus 100 in a unit period TU will be described with reference to FIG. 7.

FIG. 7 is a timing chart illustrating an example of the operation of the liquid ejecting apparatus 100 in the unit period TU. In the present embodiment, when the liquid ejecting apparatus 100 executes a printing process, a printing process period including one or a plurality of unit periods TU is set as an operation period of the liquid ejecting apparatus 100. The liquid ejecting apparatus 100 according to the present embodiment can drive each ejecting portion D for the printing process in each unit period TU. Further, the liquid ejecting apparatus 100 according to the present embodiment can drive the ejecting portion D as a detection target and detect the detection signal Vout[m] from the ejecting portion D as a detection target in each unit period TU.

FIG. 7 illustrates three sets of examples of the drive signals COMa and COMb used for evaluation of crosstalk, which are indicated by a solid line, a broken line, and a dotted line. Meanwhile, the drive signals COMa and COMb supplied to the liquid ejecting head 1 in each unit period TU are one set of the three sets of the drive signals COMa and COMb. For example, the set of the drive signals COMa and COMb supplied to the liquid ejecting head 1 in each unit period TU is selected based on a result of the evaluation of crosstalk illustrated in FIGS. 9 and 10 to be described below.

The control unit 4 outputs the latch signal LAT having a pulse PlsL. Therefore, the control unit 4 defines the unit period TU as a period from rising of the pulse PlsL to rising of the next pulse PlsL.

The print signal SI includes, for example, M individual designation signals Sd[1] to Sd[M] corresponding to the M ejecting portions D[1] to D[M] on a one-to-one basis. The individual designation signal Sd[m] designates a mode of the driving of the ejecting portion D[m] in each unit period TU when the liquid ejecting apparatus 100 executes the printing process.

The control unit 4 supplies the print signal SI including the individual designation signals Sd[1] to Sd[M] to the coupling state designation circuit CSC in synchronization with a clock signal CL before each unit period TU in which the printing process is executed. The coupling state designation circuit CSC generates the coupling state designation signals Qa[m], Qb[m], and Qs[m] based on the individual designation signal Sd[m] in the unit period TU.

For example, the ejecting portion D[m] is designated as any of the ejecting portion D that forms a dot, the ejecting portion D that does not form a dot, and the ejecting portion D as a detection target, by the individual designation signal Sd[m], in a unit period TP during which the printing process is executed. The ejecting portion D that forms a dot is the ejecting portion D in which the piezoelectric element PZ of the ejecting portion D is driven such that an ink is ejected from the nozzle N of the ejecting portion D. In addition, the ejecting portion D that does not form the dot is the ejecting portion D in which the piezoelectric element PZ of the ejecting portion D is driven such that the ink is not ejected from the nozzle N of the ejecting portion D.

First, an operation of the coupling state designation circuit CSC or the like when a driving mode as the ejecting portion D for forming a dot is designated by the individual designation signal Sd[m] will be described. When a driving mode as the ejecting portion D for forming a dot is designated by the individual designation signal Sd[m], for example, the coupling state designation circuit CSC respectively sets the coupling state designation signal Qa[m] to a high level and the coupling state designation signals Qb[m] and Qs[m] to a low level, in the unit period TU. Therefore, the drive signal COMa is supplied to the ejecting portion D that forms a dot from the drive signal generation unit 2.

For example, the drive signal generation unit 2 outputs one ejection signal DS as the drive signal COMa for ejecting the ink from the nozzle N. In the example illustrated in FIG. 7, the drive signal generation unit 2 outputs any one of an ejection signal DS1 having a pulse PA1, an ejection signal DS2 having a pulse PA2, and an ejection signal DS3 having a pulse PA3 as the drive signal COMa. The ejection signals DS1, DS2, and DS3 are also referred to as the ejection signal DS without particular distinction, and the pulses PA1, PA2, and PA3 are also referred to as a pulse PA without particular distinction. One ejection signal DS among the ejection signals DS1, DS2, and DS3 is an example of a “first ejection signal”, and each of the other ejection signals DS is an example of a “second ejection signal”.

The pulse PA is, for example, a pulse for ejecting the ink from the nozzle N. For example, the pulse PA1 is a waveform in which a potential of the ejection signal DS1 is changed from a potential VC1 and returns to the potential VC1 via a potential VLa and a potential VHa. In the same manner, the pulse PA2 is a waveform in which a potential of the ejection signal DS2 is changed from a potential VC2 and returns to the potential VC2 via the potential VLa and the potential VHa, and the pulse PA3 is a waveform in which a potential of the ejection signal DS3 is changed from a potential VC3 and returns to the potential VC3 via the potential VLa and the potential VHa.

The potential VC1 is a potential at a start and an end of the pulse PA1, and is a reference potential of the ejection signal DS1. In the same manner, the potential VC2 is a potential at a start and an end of the pulse PA2, and is a reference potential of the ejection signal DS2. The potential VC3 is a potential at a start and an end of the pulse PA3, and is a reference potential of the ejection signal DS3. In addition, the potential VLa is a potential lower than the potentials VC1, VC2, and VC3, and is an example of an “expansion potential” and a “minimum potential”. The potential VHa is a potential higher than the potentials VC1, VC2, and VC3, and is an example of a “contraction potential” and a “maximum potential”. The potentials VC1, VC2, and VC3 are potentials between the potential VLa and the potential VHa. Hereinafter, the potentials VC1, VC2, and VC3 are also referred to as a potential VC without particular distinction. The potential VC is an example of a “reference potential”. In addition, one potential VC among the potentials VC1, VC2, and VC3 is an example of a “first potential”, and each of the other potentials VC is an example of a “second potential”.

For example, the pulse PA has a waveform element Pa1 in which a potential is changed from the potential VC to the potential VLa, a waveform element Pa2 in which the potential is maintained at the potential VLa at an end of the waveform element Pa1, and a waveform element Pa3 in which the potential is changed from the potential VLa to the potential VHa. Further, the pulse PA includes a waveform element Pa4 in which the potential is maintained at the potential VHa at an end of the waveform element Pa3, and a waveform element Pa5 in which the potential is changed from the potential VHa to the potential VC. The waveform element Pa1 is an example of a “first element”, and the waveform element Pa3 is an example of a “second element”.

The waveform elements Pa1 and Pa5 are expansion elements for displacing the piezoelectric body Zb in the Z2 direction. In the expansion element, the potential of the drive signal COMa is changed for driving the piezoelectric element PZ to expand a volume of the pressure chamber CV. Therefore, in the waveform elements Pa1 and Pa5, the potential of the drive signal COMa is changed to expand the volume of the pressure chamber CV. When the volume of the pressure chamber CV expands, a surface of the ink in the nozzle N is pulled in the Z2 direction, which is a direction opposite to an ejection direction. In the following, the pulling of the surface of the ink in the nozzle N in the direction opposite to the ejection direction may be referred to as a pull.

In addition, the waveform element Pa3 is a contraction element for displacing the piezoelectric body Zb in the Z1 direction. In the contraction element, the potential of the drive signal COMa is changed for driving the piezoelectric element PZ to contract the volume of the pressure chamber CV. Therefore, in the waveform element Pa3, the potential of the drive signal COMa is changed to contract the volume of the pressure chamber CV. When the volume of the pressure chamber CV is contracted, the surface of the ink in the nozzle N is pushed out in the Z1 direction, which is the ejection direction. In the following, the act of pushing the surface of the ink in the nozzle N in the ejection direction may be referred to as a push.

In addition, the waveform elements Pa2 and Pa4 are maintenance elements for maintaining a position of the piezoelectric body Zb in the Z-axis direction. For example, in the waveform element Pa2, the potential of the drive signal COMa is maintained for driving the piezoelectric element PZ to maintain the volume of the pressure chamber CV expanded by the waveform element Pa1. In addition, for example, in the waveform element Pa4, the potential of the drive signal COMa is maintained for driving the piezoelectric element PZ to maintain the volume of the pressure chamber CV contracted by the waveform element Pa3.

In this manner, the pulse PA is a so-called pull-push-pull waveform. Meanwhile, the waveform of the drive signal COMa for ejecting the ink from the nozzle N, that is, the waveform of the ejection signal DS is not limited to the pull-push-pull waveform.

The pulse PA is determined such that a predetermined amount of ink is ejected from the ejecting portion D[m] when the individual drive signal Vin[m] having the pulse PA is supplied to the ejecting portion D[m]. In the present embodiment, a case is assumed in which the volume of the pressure chamber CV provided in the ejecting portion D[m] is reduced when a potential of the individual drive signal Vin[m] is a high potential as compared with a case where the potential is a low potential. Therefore, when the ejecting portion D[m] is driven by the individual drive signal Vin[m] having the pulse PA, the ink in the ejecting portion D[m] is ejected from the nozzle N by the waveform element Pa3 in which the potential of the individual drive signal Vin[m] is changed from the low potential to the high potential.

For example, the waveform elements Pa1, Pa2, Pa3, Pa4, and Pa5 included in the pulse PA are determined based on an ejection characteristic of the ink by the ejecting portion D and the like. The ejection characteristic of the ink is, for example, the amount of ink ejected as ink droplets, an ejection rate of the ejected ink droplets, or the like. In the present embodiment, the reference potential, which is the potential VC at a start and an end of the pulse PA, is determined such that occurrence of crosstalk is prevented.

That is, in the present embodiment, the occurrence of the crosstalk is prevented by adjusting the reference potential, which is the potential VC at the start and the end of the pulse PA. The occurrence of the crosstalk is controlled by adjusting the potential of the drive signal COMb supplied to the piezoelectric element PZ corresponding to the non-ejection nozzle N, for example, as described in FIG. 6. In the present embodiment, a case is assumed in which a potential equal to the potential of the drive signal COMb is used as the reference potential of the pulse PA. Therefore, for example, the evaluation control portion 40 evaluates crosstalk by using a plurality of ejection signals DS having different reference potentials of the pulse PA. For example, among the plurality of ejection signals DS, the ejection signal DS with which crosstalk does not occur is set as the drive signal COMa. Therefore, an ejection characteristic of an ink when the ink is ejected from one nozzle N among the plurality of nozzles N is prevented from being changed by an ejection state of another nozzle N such as the nozzle N adjacent to the one nozzle N.

Next, an operation of the coupling state designation circuit CSC or the like when a driving mode as the ejecting portion D that does not form a dot is designated by the individual designation signal Sd[m] will be described. When a driving mode as the ejecting portion D that does not form the dot is designated by the individual designation signal Sd[m], for example, the coupling state designation circuit CSC respectively sets the coupling state designation signal Qb[m] to a high level and the coupling state designation signals Qa[m] and Qs[m] to a low level, in the unit period TU. Therefore, the drive signal COMb is supplied from the drive signal generation unit 2 to the ejecting portion D that does not form the dot.

For example, the drive signal generation unit 2 outputs one holding signal HS as the drive signal COMb that does not eject the ink from the nozzle N. In the example illustrated in FIG. 7, the drive signal generation unit 2 outputs any one of a holding signal HS1 maintained at the potential VC1, a holding signal HS2 maintained at the potential VC2, and a holding signal HS3 maintained at the potential VC3 as the drive signal COMb. The holding signals HS1, HS2, and HS3 are also referred to as the holding signal HS without particular distinction. One holding signal HS among the holding signals HS1, HS2, and HS3 is an example of a “first holding signal”, and each of the other holding signals HS is an example of a “second holding signal”.

In the present embodiment, since a potential having the same potential as the potential of the drive signal COMb is set as a reference potential of the drive signal COMa, for example, when the ejection signal DS1 is selected as the drive signal COMa, the holding signal HS1 is selected as the drive signal COMb. Further, when the ejection signal DS2 is selected as the drive signal COMa, the holding signal HS2 is selected as the drive signal COMb. When the ejection signal DS3 is selected as the drive signal COMa, the holding signal HS3 is selected as the drive signal COMb.

Next, an operation of the coupling state designation circuit CSC or the like when a driving mode of the ejecting portion D as a detection target is designated by the individual designation signal Sd[m] will be described. In the following, the operation of the coupling state designation circuit CSC or the like when the driving mode of the detection target ejecting portion D is designated by the individual designation signal Sd[m] will be described with reference to a case of evaluating crosstalk. For example, when evaluating crosstalk, the ejecting portion D as a detection target is designated by the individual designation signal Sd[m] in the unit period TU for detection, which is the next unit period TU after the unit period TU in which the plurality of piezoelectric elements PZ are driven by the all ejection or the alternate ejection.

For example, when a driving mode of the ejecting portion D which is a detection target, is designated by the individual designation signal Sd[m], the coupling state designation circuit CSC sets the coupling state designation signal Qs[m] to a high level in the unit period TU for detection. Further, the coupling state designation circuit CSC sets the coupling state designation signals Qa[m] and Qb[m] to a low level in the unit period TU for detection.

In this case, the piezoelectric element PZ[m] included in the ejecting portion D[m] as a detection target is driven by the drive signal COMa in the unit period TU before the unit period TU for detection. Therefore, the piezoelectric element PZ[m] is displaced by the pulse PA of the drive signal COMa in the unit period TU before the unit period TU for detection. As a result, vibration is generated in the ejecting portion D[m] as a detection target. The vibration generated in the unit period TU before the unit period TU for detection remains even in the unit period TU for detection. Then, in the unit period TU for detection, a potential of the individual electrode Za[m] of the piezoelectric element PZ[m] included in the ejecting portion D[m] as a detection target is changed in accordance with the residual vibration generated in the ejecting portion D[m]. That is, in the unit period TU for detection, the potential of the individual electrode Za of the piezoelectric element PZ included in the ejecting portion D as a detection target becomes a potential corresponding to an electromotive force of the piezoelectric element PZ caused by the residual vibration generated in the ejecting portion D as a detection target. The potential of the individual electrode Za is detected as the detection signal Vout in the unit period TU for detection.

The coupling state designation signals Qa and Qs corresponding to the ejecting portions D other than the ejecting portion D[m] which is a detection target are set to a low level in the unit period TU for detection, for example. Further, the coupling state designation signal Qb corresponding to the ejecting portion D other than the ejecting portion D[m] which is a detection target may be set to a high level or a low level in the unit period TU for detection. For example, the coupling state designation circuit CSC may set the coupling state designation signal Qs[m] to a high level in a first half period of the unit period TU for detection, and set the coupling state designation signal Qs[m] to a low level in a second half period of the unit period TU for detection.

The operation of the liquid ejecting apparatus 100 is not limited to the example illustrated in FIG. 7. For example, in FIG. 7, a case is illustrated as an example in which there is one drive signal COM for ejecting an ink from the nozzle N, and the present disclosure is not limited to such an aspect. For example, the plurality of drive signals COM corresponding to sizes of dots may be used as the drive signal COM for ejecting the ink from the nozzle N. In this case as well, a reference potential of each of the plurality of drive signals COM corresponding to a size of the dot is set to, for example, the same potential as the potential of the drive signal COMb. The plurality of drive signals COM may include one or both of the drive signals COM having a minute vibration waveform for preventing thickening of the ink and the drive signal COM having a minute vibration waveform for generating residual vibration for detecting an ejection abnormality. In this case as well, the reference potential of the drive signal COM having the minute vibration waveform is set to, for example, the same potential as the potential of the drive signal COMb.

In addition, the drive signal COMb may not be used. In this case, the wiring Lb illustrated in FIG. 5 may be omitted. In an aspect in which the drive signal COMb is not used, for example, before the first unit period TU is started, the drive signal generation unit 2 applies the potential VC, which is the reference potential of the drive signal COMa, to all the piezoelectric elements PZ. When the driving mode as the ejecting portion D that does not form the dot is designated by the individual designation signal Sd[m], for example, the coupling state designation circuit CSC sets the coupling state designation signals Qa[m] and Qs[m] to a low level in the unit period TU. Therefore, when a leakage current does not occur, a potential of the individual electrode Za of the piezoelectric element PZ included in the ejecting portion D that does not form the dot is maintained at the potential VC before the coupling state designation signal Qa[m] is set to a low level. Therefore, in the present aspect as well, it can be considered that the piezoelectric element PZ corresponding to the non-ejection nozzle N is driven by the potential VC.

In addition, in FIG. 7, a case is illustrated as an example in which the plurality of ejection signals DS having the reference potentials which are the potentials VC at the start and the end of the pulse PA different from each other are used for the evaluation of the crosstalk. Meanwhile, the plurality of ejection signals DS having other elements different from each other may be used for the evaluation of the crosstalk, in addition to the reference potential.

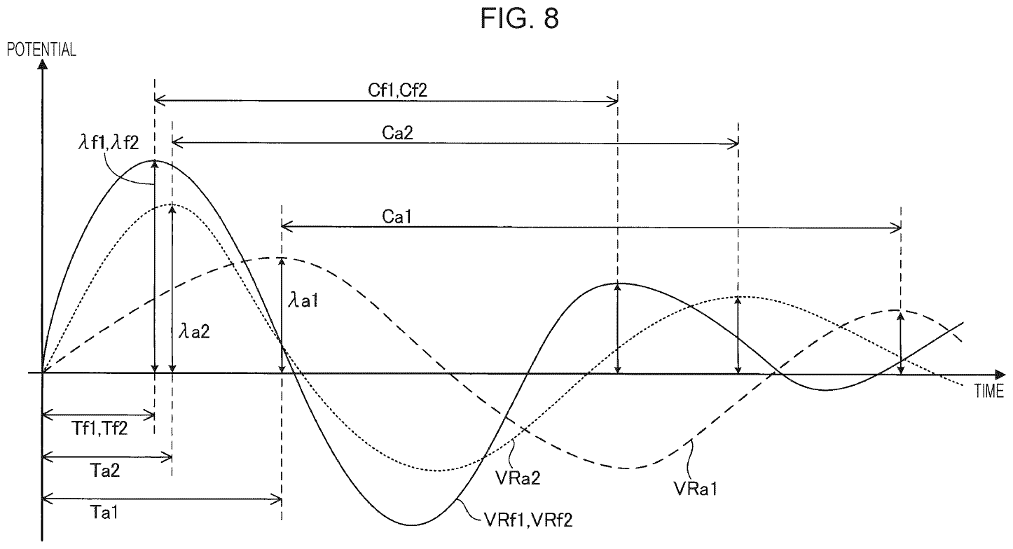

Next, an operation of the analysis portion 3 will be described with reference to FIG. 8.

FIG. 8 is a diagram illustrating an example of a waveform of the residual vibration signal VR. FIG. 8 schematically illustrates the example of the waveform of the residual vibration signal VR when all ejection and alternate ejection are performed by using each of two sets of the drive signals COMa and COMb. A vertical axis of a graph indicates a potential of the residual vibration signal VR, and a horizontal axis indicates a time. Hereinafter, a set in which the ejection signal DS1 is used as the drive signal COMa and the holding signal HS1 is used as the drive signal COMb is also referred to as a set of the ejection signal DS1 and the holding signal HS1. In the same manner, a set in which the ejection signal DS2 is used as the drive signal COMa and the holding signal HS2 is used as the drive signal COMb is also referred to as a set of the ejection signal DS2 and the holding signal HS2.

For example, a residual vibration signal VRf1 is the residual vibration signal VR indicating residual vibration when the plurality of piezoelectric elements PZ are driven by the set of the ejection signal DS1 and the holding signal HS1, in all ejection. A residual vibration signal VRf2 is the residual vibration signal VR indicating residual vibration when the plurality of piezoelectric elements PZ are driven by the set of the ejection signal DS2 and the holding signal HS2, in the all ejection. In FIG. 8, in order to make the diagram easy to see, a case is assumed in which a waveform of the residual vibration signal VRf2 is the same as a waveform of the residual vibration signal VRf1. For example, a residual vibration signal VRa1 is the residual vibration signal VR indicating residual vibration when the plurality of piezoelectric elements PZ are driven by using the set of the ejection signal DS1 and the holding signal HS1, in alternate ejection. A residual vibration signal VRa2 is the residual vibration signal VR indicating residual vibration when the plurality of piezoelectric elements PZ are driven by using the set of the ejection signal DS2 and the holding signal HS2, in the alternate ejection. That is, a difference between the residual vibration signal VRf1 and the residual vibration signal VRa1 indicates a variation in residual vibration between the all ejection and the alternate ejection when the set of the ejection signal DS1 and the holding signal HS1 is used, that is, the degree of occurrence of structural crosstalk. In the same manner, a difference between the residual vibration signal VRf2 and the residual vibration signal VRa2 indicates a variation in residual vibration between the all ejection and the alternate ejection when the set of the ejection signal DS2 and the holding signal HS2 is used, that is, the degree of occurrence of structural crosstalk. Each waveform illustrated in FIG. 8 is a waveform for describing an operation of the analysis portion 3, and does not accurately represent a relationship between the ejection signal DS and the holding signal HS illustrated in FIG. 7, and the residual vibration during the all ejection or the alternate ejection.

As described above, the residual vibration signal VR indicates a waveform corresponding to the residual vibration occurring in the ejecting portion D as a detection target, that is, the residual vibration of the diaphragm 14. Specifically, the residual vibration signal VR indicates an amplitude corresponding to an amplitude of the residual vibration of the diaphragm 14, a cycle corresponding to a cycle of the residual vibration of the diaphragm 14, and a phase corresponding to a phase of the residual vibration of the diaphragm 14.

In the example illustrated in FIG. 8, for example, the analysis portion 3 specifies an amplitude k of a first peak among peaks at which a potential of the residual vibration signal VR becomes the maximum value, that is, peaks at which a waveform of the residual vibration signal VR becomes a mountain, as an amplitude of residual vibration of the diaphragm 14. Specifically, the analysis portion 3 specifies an amplitude λf1 of a first peak at which a waveform of the residual vibration signal VRf1 becomes a mountain, as an amplitude of residual vibration of the diaphragm 14 when the plurality of piezoelectric elements PZ are driven by the set of the ejection signal DS1 and the holding signal HS1, in all ejection. In the same manner, the analysis portion 3 specifies an amplitude λf2 of a first peak at which a waveform of the residual vibration signal VRf2 becomes a mountain, as an amplitude of residual vibration of the diaphragm 14 when the plurality of piezoelectric elements PZ are driven by the set of the ejection signal DS2 and the holding signal HS2, in all ejection. In addition, the analysis portion 3 specifies an amplitude λa1 of a first peak at which a waveform of the residual vibration signal VRa1 becomes a mountain, as an amplitude of residual vibration of the diaphragm 14 when the plurality of piezoelectric elements PZ are driven by using the set of the ejection signal DS1 and the holding signal HS1, in alternate ejection. In addition, the analysis portion 3 specifies an amplitude λa2 of a first peak at which a waveform of the residual vibration signal VRa2 becomes a mountain, as an amplitude of residual vibration of the diaphragm 14 when the plurality of piezoelectric elements PZ are driven by using the set of the ejection signal DS2 and the holding signal HS2, in the alternate ejection.

The specific method of the amplitude of the residual vibration signal VR is not limited to the example described above, and a known method can be adopted. For example, the amplitude of the residual vibration signal VR may be an amplitude of a first peak at which the waveform of the residual vibration signal VR becomes a valley, or may be an average of the amplitudes of a plurality of peaks.

For example, the analysis portion 3 specifies a phase of the residual vibration signal VR, as a phase of residual vibration of the diaphragm 14. In the present embodiment, for example, a case is assumed in which a time T from a start of the unit period TU to the first peak at which the waveform of the residual vibration signal VR becomes a mountain is specified as the phase of the residual vibration signal VR.

Therefore, for example, the analysis portion 3 specifies a time Tf1 from the start of the unit period TU to the first peak at which the waveform of the residual vibration signal VRf1 becomes a mountain, as a phase of the residual vibration of the diaphragm 14 when the plurality of piezoelectric elements PZ are driven by the set of the ejection signal DS1 and the holding signal HS1, in all ejection. In the same manner, the analysis portion 3 specifies a time Tf2 from the start of the unit period TU to the first peak at which the waveform of the residual vibration signal VRf2 becomes a mountain, as a phase of the residual vibration of the diaphragm 14 when the plurality of piezoelectric elements PZ are driven by the set of the ejection signal DS2 and the holding signal HS2, in the all ejection. In addition, the analysis portion 3 specifies a time Ta1 from the start of the unit period TU to the first peak at which the waveform of the residual vibration signal VRa1 becomes a mountain, as a phase of the residual vibration of the diaphragm 14 when the plurality of piezoelectric elements PZ are driven by using the set of the ejection signal DS1 and the holding signal HS1, in alternate ejection. In addition, the analysis portion 3 specifies a time Ta2 from the start of the unit period TU to the first peak at which the waveform of the residual vibration signal VRa2 becomes a mountain, as a phase of the residual vibration of the diaphragm 14 when the plurality of piezoelectric elements PZ are driven by using the set of the ejection signal DS2 and the holding signal HS2, in the alternate ejection.

The specific method of the phase of the residual vibration signal VR is not limited to the example described above, and a known method can be adopted. For example, when a potential of the residual vibration signal VR is set as a center potential when residual vibration is attenuated and the residual vibration is settled in the diaphragm 14, a time until the potential of the residual vibration signal VR reaches a potential of a first peak of a waveform of the residual vibration signal VRf1 from the center potential may be specified as the phase of the residual vibration signal VR.

For example, the analysis portion 3 specifies a cycle of the residual vibration signal VR as a cycle of residual vibration of the diaphragm 14. In the present embodiment, for example, a case is assumed in which a time C from a first peak to the next peak among the peaks at which a waveform of the residual vibration signal VR becomes a mountain is specified, as the cycle of the residual vibration of the diaphragm 14. In the following, among the peaks at which the waveform of the residual vibration signal VR becomes a mountain, the time C from the first peak to the next peak is simply referred to as the time C from the first peak to the next peak of the residual vibration signal VR.

Therefore, for example, the analysis portion 3 specifies a time Cf1 from the first peak of the residual vibration signal VRf1 to the next peak as a cycle of residual vibration of the diaphragm 14 when the plurality of piezoelectric elements PZ are driven by the set of the ejection signal DS1 and the holding signal HS1, in all ejection. In the same manner, the analysis portion 3 specifies a time C2 from the first peak of the residual vibration signal VRf2 to the next peak as a cycle of residual vibration of the diaphragm 14 when the plurality of piezoelectric elements PZ are driven by the set of the ejection signal DS2 and the holding signal HS2, in the all ejection. The analysis portion 3 specifies a time Ca1 from the first peak to the next peak of the residual vibration signal VRa1, as a cycle of residual vibration of the diaphragm 14 when the plurality of piezoelectric elements PZ are driven by using the set of the ejection signal DS1 and the holding signal HS1, in alternate ejection. The analysis portion 3 specifies the time Ca2 from the first peak of the residual vibration signal VRa2 to the next peak, as a cycle of residual vibration of the diaphragm 14 when the plurality of piezoelectric elements PZ are driven by using the set of the ejection signal DS2 and the holding signal HS2, in the alternate ejection.

The specific method for the cycle of the residual vibration signal VR is not limited to the example described above, and a known method can be adopted. For example, when a potential of the residual vibration signal VR is set as a center potential when residual vibration of the diaphragm 14 is attenuated and the residual vibration is settled, a cycle of the residual vibration signal VR may be specified based on an interval at which the potential of the residual vibration signal VR becomes the center potential.

The analysis portion 3 outputs, for example, the residual vibration information Vinf indicating the amplitude λ specified as the amplitude of the residual vibration signal VR, the time T specified as the phase of the residual vibration signal VR, and the time C specified as the cycle of the residual vibration signal VR, to the control unit 4.

Next, an operation of the liquid ejecting apparatus 100 when evaluating crosstalk will be described with reference to FIG. 9.

FIG. 9 is a flowchart illustrating an example of an operation of the liquid ejecting apparatus 100 when evaluating crosstalk. A timing at which the operation illustrated in FIG. 9 is executed is not particularly limited, and it is preferable to be executed when the liquid ejecting apparatus 100 is used for the first time or when a use condition of the liquid ejecting apparatus 100 is changed by a change in type of ink to be used. A use condition of the liquid ejecting apparatus 100 also includes a use condition of the liquid ejecting head 1. The operation illustrated in FIG. 9 is executed on each of the plurality of liquid ejecting heads 1, for example. In addition, the nozzle N as a detection target when evaluating crosstalk is the nozzle N representing the plurality of nozzles N.

The control unit 4 functions as the evaluation control portion 40 in each step of step S100 to step S152 illustrated in FIG. 9 and in step S200. A process in step S100 is executed, for example, in a state in which the pressure chamber CV is filled with an ink to be used by a user of the liquid ejecting apparatus 100. That is, after the pressure chamber CV is filled with the ink to be used by the user, the process in step S100 is executed. The process of filling the pressure chamber CV with the ink may be executed by the evaluation control portion 40, or may be executed by a processing portion other than the evaluation control portion 40. The user is, for example, a user of the liquid ejecting apparatus 100. Further, when a manufacturer and the user of the liquid ejecting apparatus 100 are the same, the manufacturer of the liquid ejecting apparatus 100 may be regarded as the user.

First, in step S100, the evaluation control portion 40 sets a variable i to “1”. The evaluation control portion 40 executes the process in step S100, and then shifts the process to step S110.

In step S110, the evaluation control portion 40 controls the liquid ejecting head 1 such that the plurality of piezoelectric elements PZ are driven by using an i-th drive signal candidate, in all ejection. The i-th drive signal candidate is, for example, a set of the i-th ejection signal DS and the i-th holding signal HS. For example, the evaluation control portion 40 selects the i-th ejection signal DS as the drive signal COMa, and controls the liquid ejecting head 1 such that all of the plurality of piezoelectric elements PZ are driven by the selected drive signal COMa. Therefore, the plurality of piezoelectric elements PZ are driven such that inks are ejected from all the nozzles N.

Next, in step S120, the evaluation control portion 40 detects residual vibration in the nozzle N as a detection target. For example, the evaluation control portion 40 causes the detection circuit 19 to detect the residual vibration from the piezoelectric element PZ corresponding to the nozzle N as a detection target. Therefore, the residual vibration of the diaphragm 14 caused by driving the plurality of piezoelectric elements PZ such that the inks are ejected from all the nozzles N is detected by the detection circuit 19. The residual vibration detected by the detection circuit 19 is analyzed by the analysis portion 3. In the example illustrated in FIG. 6, the residual vibration at a time of all ejection detected from the piezoelectric element PZ corresponding to the nozzle N1c is analyzed by the analysis portion 3. The evaluation control portion 40 acquires the residual vibration information Vmf indicating an analysis result of the residual vibration detected by the detection circuit 19 from the analysis portion 3. The residual vibration detected in step S120 is an example of “first residual vibration”.

Next, in step S130, the evaluation control portion 40 controls the liquid ejecting head 1 such that the plurality of piezoelectric elements PZ are driven by using the i-th drive signal candidate, in alternate ejection. For example, the evaluation control portion 40 selects the i-th ejection signal DS as the drive signal COMa, and selects the i-th holding signal HS as the drive signal COMb. For example, the evaluation control portion 40 controls the liquid ejecting head 1 such that the piezoelectric element PZ adjacent to the piezoelectric element PZ driven by the drive signal COMa is driven by the drive signal COMb. Therefore, the plurality of piezoelectric elements PZ are driven such that an ink is ejected from the nozzle N as a detection target and the ink is not ejected from the nozzle N adjacent to the nozzle N as a detection target.

Next, in step S140, the evaluation control portion 40 detects residual vibration in the nozzle N as a detection target. The process in step S140 is the same as the process in step S120. In step S140, for example, the detection circuit 19 detects the residual vibration of the diaphragm 14 caused by driving the piezoelectric element PZ corresponding to the nozzle N as a detection target with the drive signal COMa and driving the piezoelectric element PZ corresponding to the nozzle N adjacent to the nozzle N as a detection target with the drive signal COMb. In the example illustrated in FIG. 6, the residual vibration at a time of the alternate ejection is detected from the piezoelectric element PZ corresponding to the nozzle N1c. The evaluation control portion 40 acquires the residual vibration information Vmf indicating an analysis result of the residual vibration detected by the detection circuit 19 from the analysis portion 3. The residual vibration detected in step S140 is an example of “second residual vibration”.

Next, in step S150, the evaluation control portion 40 determines whether or not the variable i is a final value. The final value of the variable i is, for example, the number of sets of the drive signals COMa and COMb prepared in advance as the drive signal candidates. That is, the evaluation control portion 40 determines whether or not the detection of the residual signal at the time of the all ejection and the detection of the residual signal at the time of the alternate ejection are performed for all sets of the drive signals COMa and COMb prepared in advance as the drive signal candidates.

When a result of the determination in step S150 is negative, the evaluation control portion 40 adds “1” to the variable i in step S152, and then returns the process to step S110. On the other hand, when the result of the determination in step S150 is affirmative, the evaluation control portion 40 shifts the process to step S200.

In step S200, the evaluation control portion 40 executes a comparison process of the residual vibration. For example, the evaluation control portion 40 compares a residual signal at the time of the all ejection detected in step S120 and a residual signal at the time of the alternate ejection detected in step S140, for each drive signal candidate. When the process in step S120 is executed, it is determined whether or not crosstalk occurs for each drive signal candidate, and the operation illustrated in FIG. 9 is ended.

Next, the comparison process of the residual vibration executed in step S200 will be described with reference to FIG. 10.

FIG. 10 is a flowchart illustrating an example of the comparison process of the residual vibration illustrated in FIG. 9. A series of processes in step S210 to step S262 illustrated in FIG. 10 corresponds to the process in step S200 illustrated in FIG. 9. The control unit 4 functions as the evaluation control portion 40 in each step of step S210 to step S262 illustrated in FIG. 10. The process in step S210 is executed when the result of the determination in step S150 illustrated in FIG. 9 is affirmative.

In the operation illustrated in FIG. 10, times Tfi and Tai, times Cfi and Cai, and amplitudes λfi and λai specified by a series of processes in step S100 to step S152 illustrated in FIG. 9 are used. The time Tfi, the time Cfi, and the amplitude λfi respectively indicate a phase, a cycle, and an amplitude of residual vibration caused by all ejection in which the i-th drive signal candidate is used, and are specified by the process in step S120 illustrated in FIG. 9. In addition, the time Tai, the time Cai, and the amplitude kai in FIG. 10 respectively indicate a phase, a cycle, and an amplitude of residual vibration caused by alternate ejection in which the i-th drive signal candidate is used, and are specified by the process in step S140 illustrated in FIG. 9.

First, in step S210, the evaluation control portion 40 sets the variable i to “1”. The evaluation control portion 40 executes the process in step S210, and then shifts the process to step S220.

In step S220, the evaluation control portion 40 determines whether or not the time Tai is 0.7 times or more and 1.3 times or less the time Tfi. A range of 0.7 times or more and 1.3 times or less the time Tfi is an example of a “first range”. That is, the evaluation control portion 40 determines whether or not a phase of residual vibration caused by alternate ejection in which the i-th drive signal candidate is used is included in the first range specified based on a phase of residual vibration caused by all ejection in which the i-th drive signal candidate is used. The first range is not limited to the example described above, and may be appropriately set based on data obtained by experiments or the like. In addition, for example, the first range may be a range obtained by subtracting and adding a predetermined value to the time Tfi. Meanwhile, it is preferable that the determination in step S220 is a determination as to whether or not “the time Tai and the time Tfi are values close to each other”.

When a result of the determination in step S220 is negative, the evaluation control portion 40 determines that there is crosstalk in step S252, and then shifts the process to step S260. That is, when the phase of the residual vibration caused by the alternate ejection in which the i-th drive signal candidate is used does not fall within the first range, the evaluation control portion 40 determines that crosstalk occurs with the i-th drive signal candidate. In this manner, the evaluation control portion 40 evaluates the crosstalk, based on the phase of the residual vibration caused by the alternate ejection in which the i-th drive signal candidate is used and the phase of the residual vibration caused by the all ejection in which the i-th drive signal candidate is used.

On the other hand, when a result of the determination in step S220 is affirmative, the evaluation control portion 40 shifts the process to step S230.

In step S230, the evaluation control portion 40 determines whether or not the time Cai is 0.8 times or more and 1.2 times or less the time Cfi. A range of 0.8 times or more and 1.2 times or less the time Cfi is an example of a “second range”. That is, the evaluation control portion 40 determines whether or not a cycle of residual vibration caused by the alternate ejection in which the i-th drive signal candidate is used is included in the second range specified based on a cycle of residual vibration caused by the all ejection in which the i-th drive signal candidate is used. The second range is not limited to the example described above, and may be appropriately set based on data obtained by experiments or the like. For example, the second range may be a range obtained by subtracting and adding a predetermined value to the time Cfi. Meanwhile, it is preferable that the determination in step S230 is a determination as to whether or not “the time Cai and the time Cfi are values close to each other”.

When a result of the determination in step S230 is negative, the evaluation control portion 40 determines that there is crosstalk in step S252, and then shifts the process to step S260. That is, when the cycle of the residual vibration caused by the alternate ejection in which the i-th drive signal candidate is used does not fall within the second range, the evaluation control portion 40 determines that crosstalk occurs with the i-th drive signal candidate. In this manner, the evaluation control portion 40 evaluates the crosstalk, based on the cycle of the residual vibration caused by the alternate ejection in which the i-th drive signal candidate is used and the cycle of the residual vibration caused by the all ejection in which the i-th drive signal candidate is used.

On the other hand, when a result of the determination in step S230 is affirmative, the evaluation control portion 40 shifts the process to step S240.

In step S240, the evaluation control portion 40 determines whether or not the amplitude λai is equal to or more than 0.7 times and equal to or less than 1.3 times the amplitude λfi. A range of 0.7 times or more and 1.3 times or less of the amplitude λfi is an example of a “third range”. That is, the evaluation control portion 40 determines whether or not an amplitude of residual vibration caused by the alternate ejection in which the i-th drive signal candidate is used is included in the third range specified based on an amplitude of residual vibration caused by the all ejection in which the i-th drive signal candidate is used. The third range is not limited to the example described above, and may be appropriately set based on data obtained by experiments or the like. For example, the third range may be a range obtained by subtracting and adding a predetermined value to the amplitude λfi. Meanwhile, it is preferable that the determination in step S240 is a determination as to whether or not the amplitude kai and the amplitude λfi are values close to each other.

When a result of the determination in step S240 is negative, the evaluation control portion 40 determines that there is crosstalk in step S252, and then shifts the process to step S260. That is, when the amplitude of the residual vibration caused by the alternate ejection in which the i-th drive signal candidate is used does not fall within the third range, the evaluation control portion 40 determines that crosstalk occurs with the i-th drive signal candidate. In this manner, the evaluation control portion 40 evaluates the crosstalk, based on the amplitude of the residual vibration caused by the alternate ejection in which the i-th drive signal candidate is used and the amplitude of the residual vibration caused by the all ejection in which the i-th drive signal candidate is used.

On the other hand, when the result of the determination in step S240 is affirmative, the evaluation control portion 40 determines that there is no crosstalk in step S250, and then shifts the process to step S260. That is, when a waveform of the residual vibration caused by the alternate ejection in which the i-th drive signal candidate is used coincides with or is similar to a waveform of the residual vibration caused by the all ejection in which the i-th drive signal candidate is used, the evaluation control portion 40 determines that crosstalk does not occur with the i-th drive signal candidate.

In step S260, the evaluation control portion 40 determines whether or not the variable i is a final value. That is, the evaluation control portion 40 determines whether or not the comparison of the residual vibration detected by the series of processes in step S100 to step S152 illustrated in FIG. 9 is ended.

When a result of the determination in step S260 is negative, the evaluation control portion 40 adds “1” to the variable i in step S262, and then returns the process to step S220. On the other hand, when the result of the determination in step S260 is affirmative, the evaluation control portion 40 ends the operation illustrated in FIGS. 9 and 10.

The operation of the liquid ejecting apparatus 100 when evaluating crosstalk is not limited to the examples illustrated in FIGS. 9 and 10. For example, three or more predetermined number of piezoelectric elements PZ may be selected as a target of all ejection and alternate ejection from the plurality of piezoelectric elements PZ included in the liquid ejecting head 1.

For example, in step S130 illustrated in FIG. 9, by using the i-th drive signal candidate, the piezoelectric element PZ corresponding to the nozzle N as a detection target may be driven such that only the ink is ejected. That is, in step S130 illustrated in FIG. 9, the piezoelectric element PZ corresponding to the nozzle N as a detection target may be driven by the drive signal COMa, and all the piezoelectric elements PZ other than the piezoelectric element PZ corresponding to the nozzle N as a detection target may be driven by the drive signal COMb. In the following, a case where the piezoelectric element PZ corresponding to the nozzle N as a detection target is driven by the drive signal COMa and all the piezoelectric elements PZ other than the piezoelectric element PZ corresponding to the nozzle N as a detection target are driven by the drive signal COMb may be referred to as ejection only by the nozzle N as a detection target.

In addition, for example, in addition to the residual vibration caused by the all ejection and the residual vibration caused by the alternate ejection, residual vibration caused by the ejection only by the nozzle N as a detection target may be used for the evaluation of crosstalk. Specifically, for example, the piezoelectric element PZ corresponding to the nozzle N1c illustrated in FIG. 6 may be driven by the drive signal COMa, and the piezoelectric elements PZ respectively corresponding to the nozzles N1a, N1b, N1d, N1e, and N1f may be driven by the drive signal COMb. In this case, the nozzle N1e is an example of a “fourth nozzle”, and the piezoelectric element PZ corresponding to the nozzle N1e is an example of a “fourth piezoelectric element”. In addition, the residual vibration caused by the ejection only by the nozzle N as a detection target is an example of “third residual vibration”. In the present aspect, the evaluation control portion 40 may compare the residual vibration caused by the ejection only by the nozzle N as a detection target with the residual vibration caused by the all ejection, as well as the residual vibration caused by the alternate ejection.

In addition, instead of one of the residual vibration caused by the all ejection and the residual vibration caused by the alternate ejection, or in addition to the residual vibration caused by the all ejection and the residual vibration caused by the alternate ejection, residual vibration caused by ejection of another specific pattern may be used for the evaluation of crosstalk. For example, in the ejection of the specific pattern, the plurality of piezoelectric elements PZ arranged in a predetermined direction may be driven by the drive signal COMa every two. Specifically, for example, the piezoelectric elements PZ respectively corresponding to the nozzles N1c and N1f illustrated in FIG. 6 may be driven by the drive signal COMa, and the piezoelectric elements PZ respectively corresponding to the nozzles N1a, N1b, N1d, and N1e may be driven by the drive signal COMb. In the present aspect, the evaluation control portion 40 may compare the residual vibration caused by the ejection of the specific pattern with the residual vibration caused by the all ejection, as well as the residual vibration caused by the alternate ejection. Alternatively, in the present aspect, the evaluation control portion 40 may compare the residual vibration caused by the alternate ejection with the residual vibration caused by the ejection of the specific pattern.

Further, for example, one or two of the process in step S220, the process in step S230, and the process in step S240 may be omitted.

For example, the evaluation control portion 40 may determine the waveform of the drive signal COMa and the potential of the drive signal COMb based on a result of evaluation of crosstalk. The determination of the potential of the drive signal COMb is also regarded as the determination of the waveform of the drive signal COMb. For example, in the processing illustrated in FIG. 10, the evaluation control portion 40 may adopt a drive signal candidate determined to have no crosstalk, as the drive signals COMa and COMb to be actually used in a printing process. That is, the evaluation control portion 40 may determine the waveform of the drive signal COMa and the waveform of the drive signal COMb based on the residual vibration caused by the all ejection and the residual vibration caused by the alternate ejection. In addition, for example, when a plurality of the drive signal candidates are determined to have no crosstalk, the evaluation control portion 40 may adopt, as the drive signals COMa and COMb, a drive signal candidate in which a waveform of residual vibration caused by the alternate ejection coincides with or is most similar to the waveform of the residual vibration caused by the all ejection, among the plurality of the drive signal candidates. In this manner, in the present embodiment, occurrence of crosstalk can be easily prevented by determining the waveform of each of the drive signals COMa and COMb based on the evaluation result of the crosstalk.

In the above description, in the present embodiment, the liquid ejecting apparatus 100 includes the liquid ejecting head 1 including the nozzle N1c which ejects an ink, the nozzle N1d which is disposed at a position different from a position of the nozzle N1c and ejects an ink, the first piezoelectric element PZ corresponding to the nozzle N1c, the second piezoelectric element PZ corresponding to the nozzle N1d, the diaphragm 14 that vibrates by driving at least one of the first piezoelectric element PZ and the second piezoelectric element PZ, and the detection circuit 19 that detects residual vibration of the diaphragm 14 caused by driving at least one of the first piezoelectric element PZ and the second piezoelectric element PZ, and the evaluation control portion 40. The evaluation control portion 40 evaluates crosstalk between the nozzles N1c and N1d based on first residual vibration and second residual vibration detected by the detection circuit 19, by causing the detection circuit 19 to detect, as the first residual vibration, residual vibration caused by driving the first piezoelectric element PZ and the second piezoelectric element PZ with the drive signal COMa for ejecting the ink, from the first piezoelectric element PZ, and causing the detection circuit 19 to detect, as the second residual vibration, residual vibration caused by driving the first piezoelectric element PZ with the drive signal COMa and driving the second piezoelectric element PZ by the drive signal COMb for not ejecting the ink, from the first piezoelectric element PZ. In addition, the evaluation control portion 40 may determine a waveform of the drive signal COMa and a waveform of the drive signal COMb based on the first residual vibration and the second residual vibration detected by the detection circuit 19.

In this manner, in the present embodiment, the evaluation control portion 40 evaluates crosstalk between the nozzles N1c and N1d based on the first residual vibration when the ink is ejected from both of the nozzles N1c and N1d and the second residual vibration when the ink is not ejected from the nozzle N1d. Therefore, in the present embodiment, crosstalk can be appropriately and easily evaluated. In particular, in the present embodiment, so-called structural crosstalk occurring caused by a structure of the liquid ejecting head 1 such as arrangement of the nozzles N can be appropriately and easily evaluated. In the present embodiment, the evaluation control portion 40 determines the waveform of the drive signal COMa and the waveform of the drive signal COMb based on the first residual vibration and the second residual vibration, and thus the waveform of the drive signal COMa for driving the piezoelectric element PZ can be appropriately and easily determined. For example, in the present embodiment, the evaluation control portion 40 determines the waveform of the drive signal COMa and the waveform of the drive signal COMb based on the evaluation result of crosstalk, and thus the waveform of the drive signal COMa for driving the piezoelectric element PZ can be appropriately and easily determined.

In the present embodiment, the evaluation control portion 40 may perform detection of the second residual vibration in each of a case where the holding signal HS1 maintained at the potential VC1 is used as the drive signal COMb and a case where the holding signal HS2 maintained at the potential VC2 higher than the potential VC1 is used as the drive signal COMb. In the present aspect, whether the potential of the drive signal COMb is preferably set to the potential VC1 or the potential VC2 can be easily determined.

In the present embodiment, the evaluation control portion 40 may perform detection of the first residual vibration in each of a case where the ejection signal DS1 is used as the drive signal COMa and a case where the ejection signal DS2 is used as the drive signal COMa. Each of the waveforms of the ejection signal DS1 and the ejection signal DS2 includes the waveform element Pa1 in which the potential is changed from a reference potential between the potential VLa and the potential VHa, and the waveform element Pa3 which is an element after the waveform element Pa1 and in which the potential is changed from the potential VLa to the potential VHa. The reference potential of the ejection signal DS1 is the potential VC1, and the reference potential of the ejection signal DS2 is the potential VC2. In the present aspect, whether the reference potential of the drive signal COMa is preferably set to the potential VC1 or the potential VC2 can be easily determined.

In the present embodiment, the evaluation control portion 40 may evaluate crosstalk, based on the first residual vibration and the second residual vibration detected by the detection circuit 19 when the ejection signal DS1 is used as the drive signal COMa and the holding signal HS1 is used as the drive signal COMb, and the first residual vibration and the second residual vibration detected by the detection circuit 19 when the ejection signal DS2 is used as the drive signal COMa and the holding signal HS2 is used as the drive signal COMb. In the present aspect, whether it is preferable to adopt a set of the ejection signal DS1 and the holding signal HS1 as a set of the drive signals COMa and COMb, or it is preferable to adopt a set of the ejection signal DS2 and the holding signal HS2 can be easily determined.

In the present embodiment, the nozzle N1c and the nozzle N1d may be disposed at positions adjacent to each other. In this case, structural crosstalk can be evaluated with high accuracy.

In the present embodiment, the liquid ejecting head 1 further includes the nozzle N1b that is disposed at a position adjacent to the nozzle N1c and ejects an ink, and the third piezoelectric element PZ that corresponds to the nozzle N1b. The diaphragm 14 vibrates by driving at least one of the first piezoelectric element PZ, the second piezoelectric element PZ, and the third piezoelectric element PZ. The nozzle N1b, the nozzle N1c, and the nozzle N1d are arranged in this order in the Y-axis direction. The evaluation control portion 40 may cause the detection circuit 19 to detect, as the first residual vibration, residual vibration caused by driving the first piezoelectric element PZ, the second piezoelectric element PZ, and the third piezoelectric element PZ with the drive signal COMa, from the first piezoelectric element PZ, and may cause the detection circuit 19 to detect, as the second residual vibration, residual vibration caused by driving the first piezoelectric element PZ with the drive signal COMa and driving the second piezoelectric element PZ and the third piezoelectric element PZ with the drive signal COMb, from the first piezoelectric element PZ. In the present aspect as well, structural crosstalk can be evaluated with high accuracy.

In the present embodiment, the liquid ejecting head 1 further includes the nozzle N1e that is disposed at a position adjacent to the nozzle N1d and ejects the ink, and the fourth piezoelectric element PZ that corresponds to the nozzle N1e. The diaphragm 14 vibrates by driving at least one of the first piezoelectric element PZ, the second piezoelectric element PZ, and the fourth piezoelectric element PZ. The nozzle N1c, the nozzle N1d, and the nozzle N1e are arranged in this order in the Y-axis direction. The evaluation control portion 40 may evaluate crosstalk based on first residual vibration, second residual vibration, and third residual vibration detected by the detection circuit 19, by causing the detection circuit 19 to detect, as the first residual vibration, residual vibration caused by driving the first piezoelectric element PZ, the second piezoelectric element PZ, and the fourth piezoelectric element PZ with the drive signal COMa, from the first piezoelectric element PZ, causing the detection circuit 19 to detect, as the second residual vibration, residual vibration caused by driving the first piezoelectric element PZ and the fourth piezoelectric element PZ with the drive signal COMa and driving the second piezoelectric element PZ with the drive signal COMb, from the first piezoelectric element PZ, and causing the detection circuit 19 to detect, as the third residual vibration, residual vibration caused by driving the first piezoelectric element PZ with the drive signal COMa and driving the second piezoelectric element PZ and the fourth piezoelectric element PZ with the drive signal COMb, from the first piezoelectric element PZ. In the present aspect as well, structural crosstalk can be evaluated with high accuracy.

In the present embodiment, the evaluation control portion 40 may evaluate crosstalk based on a phase of the first residual vibration and a phase of the second residual vibration. In the present aspect as well, crosstalk can be easily evaluated with high accuracy.

In the present embodiment, the evaluation control portion 40 may evaluate that crosstalk occurs when the phase of the second residual vibration is not included in a first range specified based on the phase of the first residual vibration. In the present aspect as well, crosstalk can be easily evaluated with high accuracy.

In the present embodiment, the evaluation control portion 40 may evaluate crosstalk based on a cycle of the first residual vibration and a cycle of the second residual vibration. In the present aspect as well, crosstalk can be easily evaluated with high accuracy.

In the present embodiment, the evaluation control portion 40 may evaluate that crosstalk occurs when the cycle of the second residual vibration is not included in a second range specified based on the cycle of the first residual vibration. In the present aspect as well, crosstalk can be easily evaluated with high accuracy.

In the present embodiment, the evaluation control portion 40 may evaluate crosstalk based on an amplitude of the first residual vibration and an amplitude of the second residual vibration. In the present aspect as well, crosstalk can be easily evaluated with high accuracy.

In the present embodiment, the evaluation control portion 40 may evaluate that crosstalk occurs when the amplitude of the second residual vibration is not included in a third range specified based on the amplitude of the first residual vibration. In the present aspect as well, crosstalk can be easily evaluated with high accuracy.

### 2. Modification Example

Each embodiment above can be variously modified. A specific aspect of the modification will be described below. Two or more aspects selected in any manner from the following examples can be appropriately combined with each other within a range not inconsistent with each other. In addition, in the modification examples described below, elements having the same effects and functions as those of the embodiment will be given the reference numerals used in the description above, and each detailed description thereof will be appropriately omitted.

### First Modification Example

In the embodiment described above, the drive signal COM for detecting an ejection abnormality of the nozzle N may be supplied from the drive signal generation unit 2 to the liquid ejecting head 1.

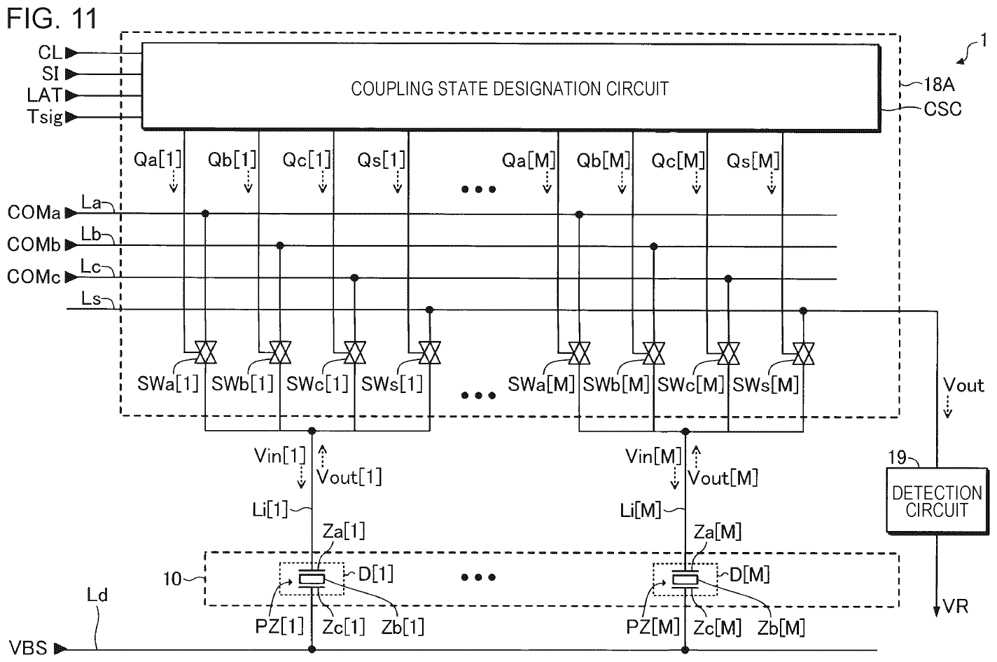

FIG. 11 is a block diagram illustrating an example of a configuration of the liquid ejecting head 1 according to a first modification example. The liquid ejecting head 1 illustrated in FIG. 11 has the same manner as the liquid ejecting head 1 illustrated in FIG. 5, except that a drive signal COMc for detecting an ejection abnormality of the nozzle N is supplied from the drive signal generation unit 2. Specifically, the liquid ejecting head 1 illustrated in FIG. 11 has the same manner as the liquid ejecting head 1 illustrated in FIG. 5, except that the liquid ejecting head 1 includes a switching circuit 18A instead of the switching circuit 18 illustrated in FIG. 5.

The switching circuit 18A has the same manner as the switching circuit 18, except that a wiring Lc to which the drive signal COMc is supplied from the drive signal generation unit 2 and M switches SWc[1] to SWb[M] corresponding to the M ejecting portions D[1] to D[M] are added to the switching circuit 18 illustrated in FIG. 5 on a one-to-one basis. Meanwhile, the coupling state designation circuit CSC generates coupling state designation signals Qa[m], Qb[m], Qc[m], and Qs[m], based on at least some of the print signal SI, a latch signal LAT, and a period designation signal Tsig, which are supplied from the control unit 4.

The switch SWc[m] switches conduction and non-conduction between the wiring Lc and the individual electrode Za[m] of the piezoelectric element PZ[m] provided in the ejecting portion D[m] based on the coupling state designation signal Qc[m]. That is, the switch SWc[m] switches conduction and non-conduction between the wiring Lc and the wiring Li[m] coupled to the individual electrode Za[m], based on the coupling state designation signal Qc[m]. In the present modification example, the switch SWc[m] is turned on when the coupling state designation signal Qc[m] is at a high level, and is turned off when the coupling state designation signal Qc[m] is at a low level. When the switch SWc[m] is turned on, the drive signal COMc supplied to the wiring Lc is supplied to the individual electrode Za[m] of the ejecting portion D[m] as the individual drive signal Vin[m] via the wiring Li[m].

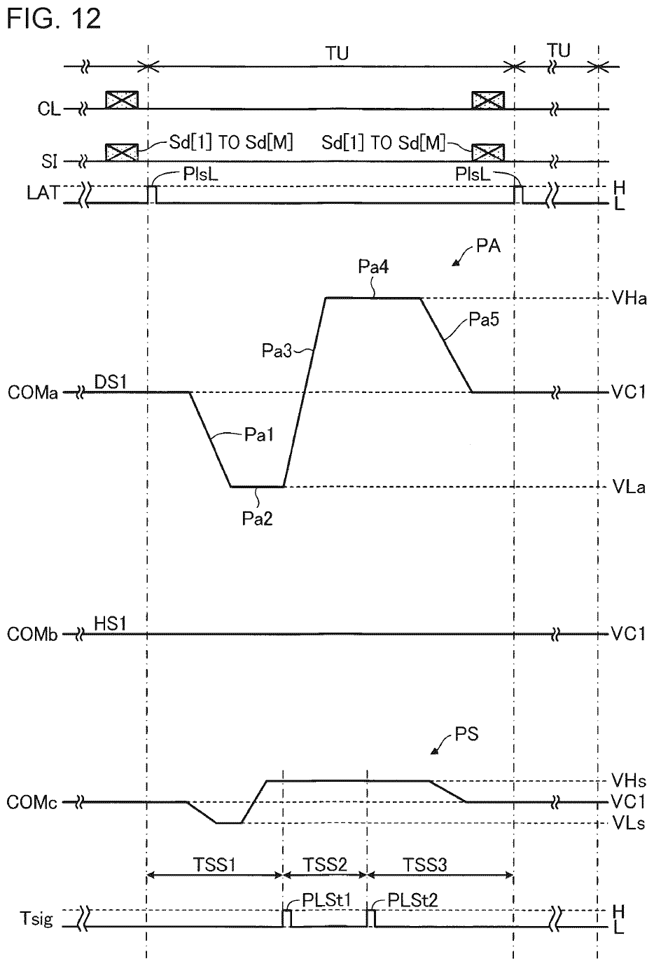

Next, an operation of the liquid ejecting apparatus 100 according to the first modification example will be described with reference to FIG. 12.

FIG. 12 is a timing chart illustrating an example of the operation of the liquid ejecting apparatus 100 according to the first modification example. The operation of the coupling state designation circuit CSC or the like when a driving mode as the ejecting portion D that forms dots, the ejecting portion D that does not form the dots, and the ejecting portion D as a detection target when evaluating crosstalk is designated by the individual designation signal Sd[m] has the same manner as the operation described in FIG. 7. Therefore, in FIG. 12, the operation of the coupling state designation circuit CSC or the like when a driving mode as the ejecting portion D, which is an ejection abnormality detection target of the nozzle N, is designated by the individual designation signal Sd[m] will be described. In FIG. 12, a case is assumed in which a reference potential of the drive signal COMa and a potential of the drive signal COMb are set to the potential VC1 based on an evaluation result of crosstalk. In this case, it is preferable that a reference potential of the drive signal COMc is also set to the potential VC1.

For example, the drive signal generation unit 2 outputs the drive signal COMc having a pulse PS. The pulse PS is a waveform in which a potential of the drive signal COMc is changed from the potential VC1 to the potential VC1 and returns to the potential VC1 via a potential VLs lower than the potential VC1 and a potential VHs higher than the potential VC1. In the present modification example, the pulse PS is determined such that a potential difference between the potential VHs, which is the highest potential of the pulse PS, and the potential VLS, which is the lowest potential of the pulse PS, is less than a potential difference between the potential VHa, which is the highest potential of the pulse PA, and the potential VLa, which is the lowest potential of the pulse PA. Specifically, when the drive signal COMc having the pulse PS is supplied to the ejecting portion D[m], a waveform of the pulse PS is determined to drive the ejecting portion D[m] to the extent that an ink is not ejected from the ejecting portion D[m]. As described above, the potential of the pulse PS at the start and the end is set to the potential VC1.

The control unit 4 outputs the period designation signal Tsig having a pulse PLSt1 and a pulse PLSt2. Therefore, the control unit 4 divides the unit period TU into a control period TSS1 from a start of the pulse PlsL to a start of the pulse PLSt1, a control period TSS2 from a start of the pulse PLSt1 to a start of the pulse PLSt2, and a control period TSS3 from a start of the pulse PLSt2 to a start of the next pulse PlsL.

For example, when the individual designation signal Sd[m] designates the ejecting portion D[m] as the ejecting portion D, which is an ejection abnormality detection target, the coupling state designation circuit CSC sets the coupling state designation signals Qa[m] and Qb[m] to a low level in the unit period TU. Further, the coupling state designation circuit CSC sets the coupling state designation signal Qc[m] to a high level in the control periods TSS1 and TSS3 and to a low level in the control period TSS2, respectively. Further, the coupling state designation circuit CSC sets the coupling state designation signal Qs[m] to a low level in the control periods TSS1 and TSS3 and to a high level in the control period TSS2, respectively.

In this case, the piezoelectric element PZ[m] included in the ejecting portion D[m] as an ejection abnormality detection target is driven by the pulse PS of the drive signal COMc in the control period TSS1. Specifically, the piezoelectric element PZ[m] is displaced by the pulse PS of the drive signal COMc in the control period TSS1. As a result, vibration is generated in the ejecting portion D[m] as a detection target. The vibration generated in the control period TSS1 remains in the control period TSS2. In the control period TSS2, the potential of the individual electrode Za[m] of the piezoelectric element PZ[m] included in the ejecting portion D[m] as a detection target is changed in accordance with the residual vibration generated in the ejecting portion D[m]. That is, in the control period TSS2, the potential of the individual electrode Za of the piezoelectric element PZ included in the ejecting portion D as a detection target is a potential corresponding to an electromotive force of the piezoelectric element PZ caused by the residual vibration generated in the ejecting portion D as a detection target. The potential of the individual electrode Za is detected as the detection signal Vout in the control period TSS2.

In FIG. 12, a case is illustrated as an example in which the detection signal Vout indicating the residual vibration of the ejecting portion D as an ejection abnormality detection target is generated during a printing process period, and the detection signal Vout may be generated during a period different from the printing process period. That is, the process of detecting the residual vibration of the ejecting portion D, which is an ejection abnormality detection target, may be executed in a period different from the printing process period. Further, in the present modification example as well, the drive signal COMb may not be used. In this case, the wiring Lb illustrated in FIG. 11 may be omitted.

As described above, in the present modification example as well, the same effect as the effect of the embodiment described above can be obtained. In addition, in the present modification example, an ejection abnormality of the nozzle N can be detected based on the residual vibration detected by the drive signal COMc.

### Second Modification Example

In the embodiment and the first modification example described above, a waveform information indicating a drive signal candidate may be stored in advance in a storage unit (not illustrated) of the liquid ejecting head 1 at a time point when a head manufacturer manufactures the liquid ejecting head 1. Alternatively, the waveform information indicating the drive signal candidate may be stored in the storage unit 5 or the like from the head manufacturer via a network (not illustrated) after the shipment of the liquid ejecting head 1. For example, the waveform information indicating the drive signal candidate prepared by the head manufacturer is read from the storage unit 5 or the like in which the waveform information indicating the drive signal candidate is stored when the operation illustrated in FIG. 9 is executed.

As described above, in the present modification example as well, the same effect as the effect of the embodiment described above can be obtained.

### Third Modification Example

In the embodiment and modification example described above, a case is described in which the control unit 4 executes analysis on residual vibration detected by the detection circuit 19, and the present disclosure is not limited to such an aspect. For example, the analysis of the residual vibration detected by the detection circuit 19 may be executed by a control unit such as a CPU of an external server managed by the head manufacturer. In the present modification example, the liquid ejecting apparatus 100 includes a communication unit which can communicate with an external server managed by the head manufacturer. For example, the control unit 4 transmits residual vibration data indicating the residual vibration detected by the detection circuit 19 to the external server managed by the head manufacturer via the communication unit. The control unit of the external server analyzes the residual vibration data transmitted from the liquid ejecting apparatus 100. Specifically, for example, the control unit of the external server specifies an amplitude, a phase, and a cycle of the residual vibration at a time of all ejection, and specifies the amplitude, phase, and cycle of the residual signal at a time of alternate ejection, and compares the residual vibration at the time of the all ejection with the residual signal at the time of the alternate ejection based on the specified result. Then, the control unit of the external server may determine the presence or absence of crosstalk based on the comparison result between the residual vibration at the time of the all ejection and the residual signal at the time of the alternate ejection, and may transmit an analysis result indicating the presence or absence of crosstalk or the like to the liquid ejecting apparatus 100. Alternatively, the control unit of the external server may specify which drive signal COM is to be used to prevent occurrence of crosstalk based on the comparison result between the residual vibration at the time of the all ejection and the residual signal at the time of the alternate ejection, and may transmit information indicating the specifying result to the liquid ejecting apparatus 100.

As described above, in the present modification example as well, the same effect as the effect of the embodiment described above can be obtained.

### Fourth Modification Example

In the embodiment and modification example described above, a case is described as an example in which the piezoelectric body Zb is displaced in the Z1 direction by changing a potential of the individual drive signal Vin[m] from a low potential to a high potential, and the present disclosure is not limited to such an aspect. For example, the piezoelectric body Zb that is displaced in the Z1 direction by the potential of the individual drive signal Vin[m] changing from the high potential to the low potential may be used. In this case, for example, the potential of the drive signal COM is changed from the low potential to the high potential in a portion corresponding to an expansion element, and is changed from the high potential to the low potential in a portion corresponding to a contraction element. That is, in the present modification example, the potential corresponding to the “expansion potential” is a potential higher than the potential VC, and the potential corresponding to the “contraction potential” is a potential lower than the potential VC. In the present modification example as well, the same effect as the effect of the embodiment and modification examples described above can be obtained.

### Fifth Modification Example

In the embodiment and the modification example described above, a case is described as an example in which one piezoelectric element PZ, one pressure chamber CV, and one nozzle N are provided for one ejecting portion D, and the present disclosure is not limited to such an aspect. For example, one ejecting portion D may have two piezoelectric elements PZ, two pressure chambers CV, and one nozzle N. As described above, in the present modification example as well, the same effect as the effect of the embodiment and modification example described above can be obtained.

### Sixth Modification Example

In the embodiment and the modification example described above, the liquid ejecting apparatus 100 having a serial method in which the carriage 91 at which the liquid ejecting head 1 is mounted is reciprocated in the X-axis direction is described, and the present disclosure is not limited to such an aspect. For example, the liquid ejecting apparatus 100 may have a line method liquid ejecting apparatus in which the plurality of nozzles N are distributed over an entire width of the medium PP. As described above, in the present modification example as well, the same effect as the effect of the embodiment and modification example described above can be obtained.

### Seventh Modification Example

The liquid ejecting apparatus 100 described in the embodiment and the modification example described above can be adopted in various devices such as a facsimile machine and a copying machine, in addition to a device dedicated to printing. Moreover, the application of the liquid ejecting apparatus of the present disclosure is not limited to printing. For example, a liquid ejecting apparatus that ejects a solution of a coloring material is used as a manufacturing device that forms a color filter of a liquid crystal display device. In addition, a liquid ejecting apparatus that ejects a solution of a conductive material is used as a manufacturing apparatus that forms a wire or an electrode of a wiring substrate. As described above, in the present modification example as well, the same effect as the effect of the embodiment and modification example described above can be obtained.

### 3. Appendixes

From the embodiments described above, for example, the following configuration can be ascertained.

According to Aspect 1 that is a preferred aspect, there is provided a liquid ejecting apparatus including: a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element; and a control portion, in which the control portion causes the detection portion to detect, as first residual vibration, the residual vibration caused by driving the first piezoelectric element and the second piezoelectric element with an ejection signal for ejecting the liquid, from the first piezoelectric element, causes the detection portion to detect, as second residual vibration, the residual vibration caused by driving the first piezoelectric element with the ejection signal and driving the second piezoelectric element with a holding signal for not ejecting the liquid, from the first piezoelectric element, and evaluates crosstalk between the first nozzle and the second nozzle based on the first residual vibration and the second residual vibration detected by the detection portion.

With Aspect 1, crosstalk can be appropriately and easily evaluated.

In the liquid ejecting apparatus according to Aspect 2 that is a specific example of Aspect 1, the control portion performs detection of the second residual vibration in each of a case where a first holding signal maintained at a first potential is used as the holding signal and a case where a second holding signal maintained at a second potential higher than the first potential is used as the holding signal.

With Aspect 2, whether a potential of the holding signal is preferably set to the first potential or the second potential can be easily determined.

In the liquid ejecting apparatus according to Aspect 3 that is a specific example of Aspect 2, the control portion performs detection of the first residual vibration in each of a case where a first ejection signal is used as the ejection signal and a case where a second ejection signal is used as the ejection signal, a waveform of each of the first ejection signal and the second ejection signal includes a first element in which a potential is changed from a reference potential between an expansion potential and a contraction potential to the expansion potential, and a second element in which a potential is changed from the expansion potential to the contraction potential, which is an element after the first element, the reference potential of the first ejection signal is the first potential, and the reference potential of the second ejection signal is the second potential.

With Aspect 3, whether the reference potential of the ejection signal is preferably set to the first potential or the second potential can be easily determined.

In the liquid ejecting apparatus according to Aspect 4 that is a specific example of Aspect 3, the control portion evaluates the crosstalk based on the first residual vibration and the second residual vibration detected by the detection portion when the first ejection signal is used as the ejection signal and the first holding signal is used as the holding signal, and the first residual vibration and the second residual vibration detected by the detection portion when the second ejection signal is used as the ejection signal and the second holding signal is used as the holding signal.

With Aspect 4, whether it is preferable to adopt a set of the first ejection signal and the first holding signal as a set of the ejection signal and the holding signal or to adopt a set of the second ejection signal and the second holding signal as the set of the ejection signal and the holding signal can be easily determined.

In the liquid ejecting apparatus according to Aspect 5 that is a specific example of any one of Aspects 1 to 4, the first nozzle and the second nozzle are disposed at positions adjacent to each other.

With Aspect 5, structural crosstalk can be evaluated with high accuracy.

In the liquid ejecting apparatus according to Aspect 6 that is a specific example of Aspect 5, the liquid ejecting head further includes a third nozzle which is disposed at a position adjacent to the first nozzle and ejects the liquid, and a third piezoelectric element which corresponds to the third nozzle, the diaphragm vibrates by driving at least one of the first piezoelectric element, the second piezoelectric element, and the third piezoelectric element, the third nozzle, the first nozzle, and the second nozzle are arranged in this order in a predetermined direction, and the control portion causes the detection portion to detect, as the first residual vibration, the residual vibration caused by driving the first piezoelectric element, the second piezoelectric element, and the third piezoelectric element with the ejection signal, from the first piezoelectric element, and causes the detection portion to detect, as the second residual vibration, the residual vibration caused by driving the first piezoelectric element with the ejection signal and driving the second piezoelectric element and the third piezoelectric element with the holding signal, from the first piezoelectric element.

With Aspect 6 as well, structural crosstalk can be evaluated with high accuracy.

In the liquid ejecting apparatus according to Aspect 7 that is a specific example of Aspect 5, the liquid ejecting head further includes a fourth nozzle which is disposed at a position adjacent to the second nozzle and ejects the liquid, and a fourth piezoelectric element which corresponds to the fourth nozzle, the diaphragm vibrates by driving at least one of the first piezoelectric element, the second piezoelectric element, and the fourth piezoelectric element, the first nozzle, the second nozzle, and the fourth nozzle are arranged in this order in a predetermined direction, and the control portion causes the detection portion to detect, as the first residual vibration, the residual vibration caused by driving the first piezoelectric element, the second piezoelectric element, and the fourth piezoelectric element with the ejection signal, from the first piezoelectric element, causes the detection portion to detect, as the second residual vibration, the residual vibration caused by driving the first piezoelectric element and the fourth piezoelectric element with the ejection signal and driving the second piezoelectric element with the holding signal, from the first piezoelectric element, causes the detection portion to detect, as third residual vibration, the residual vibration caused by driving the first piezoelectric element with the ejection signal and driving the second piezoelectric element and the fourth piezoelectric element with the holding signal, from the first piezoelectric element, and evaluates the crosstalk based on the first residual vibration, the second residual vibration, and the third residual vibration detected by the detection portion.

With Aspect 7 as well, structural crosstalk can be evaluated with high accuracy.

In the liquid ejecting apparatus according to Aspect 8 that is a specific example of any one of Aspects 1 to 6, the control portion evaluates the crosstalk based on a phase of the first residual vibration and a phase of the second residual vibration.

With Aspect 8, crosstalk can be easily evaluated with high accuracy.

In the liquid ejecting apparatus according to Aspect 9 that is a specific example of Aspect 8, when the phase of the second residual vibration is not included in a first range specified based on the phase of the first residual vibration, the control portion evaluates that the crosstalk occurs.

With Aspect 9 as well, crosstalk can be easily evaluated with high accuracy.

In the liquid ejecting apparatus according to Aspect 10 that is a specific example of any one of Aspects 1 to 6, Aspect 8, and Aspect 9, the control portion evaluates the crosstalk based on a cycle of the first residual vibration and a cycle of the second residual vibration.

With Aspect 10 as well, crosstalk can be easily evaluated with high accuracy.

In the liquid ejecting apparatus according to Aspect 11 that is a specific example of Aspect 10, when the cycle of the second residual vibration is not included in a second range specified based on the cycle of the first residual vibration, the control portion evaluates that the crosstalk occurs.

With Aspect 11 as well, crosstalk can be easily evaluated with high accuracy.

In the liquid ejecting apparatus according to Aspect 12 that is a specific example of any one of Aspects 1 to 6 and Aspects 8 to 10, the control portion evaluates the crosstalk based on an amplitude of the first residual vibration and an amplitude of the second residual vibration.

With Aspect 12 as well, crosstalk can be easily evaluated with high accuracy.

In the liquid ejecting apparatus according to Aspect 13 that is a specific example of Aspect 12, when the amplitude of the second residual vibration is not included in a third range specified based on the amplitude of the first residual vibration, the control portion evaluates that the crosstalk occurs.

With Aspect 13 as well, crosstalk can be easily evaluated with high accuracy.

According to Aspect 14 that is another preferred aspect, there is provided a liquid ejecting apparatus including: a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element; and a control portion, in which the control portion causes the detection portion to detect, as first residual vibration, the residual vibration caused by driving the first piezoelectric element and the second piezoelectric element with an ejection signal for ejecting the liquid, from the first piezoelectric element, causes the detection portion to detect, as second residual vibration, the residual vibration caused by driving the first piezoelectric element with the ejection signal and driving the second piezoelectric element with a holding signal for not ejecting the liquid, from the first piezoelectric element, and determines a waveform of the ejection signal and a waveform of the holding signal based on the first residual vibration and the second residual vibration detected by the detection portion.

With Aspect 14, the waveform of the drive signal for driving the piezoelectric element can be appropriately and easily determined.

According to Aspect 15 that is still another preferred aspect, there is provided a control method for a liquid ejecting apparatus including a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element, the method including: causing the detection portion to detect, as first residual vibration, the residual vibration caused by driving the first piezoelectric element and the second piezoelectric element with an ejection signal for ejecting the liquid, from the first piezoelectric element; causing the detection portion to detect, as second residual vibration, the residual vibration caused by driving the first piezoelectric element with the ejection signal and driving the second piezoelectric element with a holding signal for not ejecting the liquid, from the first piezoelectric element; and evaluating crosstalk between the first nozzle and the second nozzle based on the first residual vibration and the second residual vibration detected by the detection portion.

With Aspect 15, crosstalk can be appropriately and easily evaluated.

What is claimed is:

1. A liquid ejecting apparatus comprising:
a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element; and
a control portion, wherein
the control portion
causes the detection portion to detect, as first residual vibration, the residual vibration caused by driving the first piezoelectric element and the second piezoelectric element with an ejection signal for ejecting the liquid, from the first piezoelectric element,
causes the detection portion to detect, as second residual vibration, the residual vibration caused by driving the first piezoelectric element with the ejection signal and driving the second piezoelectric element with a holding signal for not ejecting the liquid, from the first piezoelectric element, and
evaluates crosstalk between the first nozzle and the second nozzle based on the first residual vibration and the second residual vibration detected by the detection portion.

2. The liquid ejecting apparatus according to claim 1, wherein
the control portion performs detection of the second residual vibration in each of a case where a first holding signal maintained at a first potential is used as the holding signal and a case where a second holding signal maintained at a second potential higher than the first potential is used as the holding signal.

3. The liquid ejecting apparatus according to claim 2, wherein
the control portion performs detection of the first residual vibration in each of a case where a first ejection signal is used as the ejection signal and a case where a second ejection signal is used as the ejection signal,
a waveform of each of the first ejection signal and the second ejection signal includes
a first element in which a potential is changed from a reference potential between an expansion potential and a contraction potential to the expansion potential, and
a second element in which a potential is changed from the expansion potential to the contraction potential, which is an element after the first element,
the reference potential of the first ejection signal is the first potential, and
the reference potential of the second ejection signal is the second potential.

4. The liquid ejecting apparatus according to claim 3, wherein
the control portion evaluates the crosstalk based on
the first residual vibration and the second residual vibration detected by the detection portion when the first ejection signal is used as the ejection signal and the first holding signal is used as the holding signal, and
the first residual vibration and the second residual vibration detected by the detection portion when the second ejection signal is used as the ejection signal and the second holding signal is used as the holding signal.

5. The liquid ejecting apparatus according to claim 1, wherein
the first nozzle and the second nozzle are disposed at positions adjacent to each other.

6. The liquid ejecting apparatus according to claim 5, wherein
the liquid ejecting head further includes a third nozzle which is disposed at a position adjacent to the first nozzle and ejects the liquid, and a third piezoelectric element which corresponds to the third nozzle,
the diaphragm vibrates by driving at least one of the first piezoelectric element, the second piezoelectric element, and the third piezoelectric element,
the third nozzle, the first nozzle, and the second nozzle are arranged in this order in a predetermined direction, and
the control portion
causes the detection portion to detect, as the first residual vibration, the residual vibration caused by driving the first piezoelectric element, the second piezoelectric element, and the third piezoelectric element with the ejection signal, from the first piezoelectric element, and
causes the detection portion to detect, as the second residual vibration, the residual vibration caused by driving the first piezoelectric element with the ejection signal and driving the second piezoelectric element and the third piezoelectric element with the holding signal, from the first piezoelectric element.

7. The liquid ejecting apparatus according to claim 5, wherein
the liquid ejecting head further includes a fourth nozzle which is disposed at a position adjacent to the second nozzle and ejects the liquid, and a fourth piezoelectric element which corresponds to the fourth nozzle,
the diaphragm vibrates by driving at least one of the first piezoelectric element, the second piezoelectric element, and the fourth piezoelectric element,
the first nozzle, the second nozzle, and the fourth nozzle are arranged in this order in a predetermined direction, and
the control portion
causes the detection portion to detect, as the first residual vibration, the residual vibration caused by driving the first piezoelectric element, the second piezoelectric element, and the fourth piezoelectric element with the ejection signal, from the first piezoelectric element,
causes the detection portion to detect, as the second residual vibration, the residual vibration caused by driving the first piezoelectric element and the fourth piezoelectric element with the ejection signal and driving the second piezoelectric element with the holding signal, from the first piezoelectric element,
causes the detection portion to detect, as third residual vibration, the residual vibration caused by driving the first piezoelectric element with the ejection signal and driving the second piezoelectric element and the fourth piezoelectric element with the holding signal, from the first piezoelectric element, and
evaluates the crosstalk based on the first residual vibration, the second residual vibration, and the third residual vibration detected by the detection portion.

8. The liquid ejecting apparatus according to claim 1, wherein
the control portion evaluates the crosstalk based on a phase of the first residual vibration and a phase of the second residual vibration.

9. The liquid ejecting apparatus according to claim 8, wherein
when the phase of the second residual vibration is not included in a first range specified based on the phase of the first residual vibration, the control portion evaluates that the crosstalk occurs.

10. The liquid ejecting apparatus according to claim 1, wherein
the control portion evaluates the crosstalk based on a cycle of the first residual vibration and a cycle of the second residual vibration.

11. The liquid ejecting apparatus according to claim 10, wherein
when the cycle of the second residual vibration is not included in a second range specified based on the cycle of the first residual vibration, the control portion evaluates that the crosstalk occurs.

12. The liquid ejecting apparatus according to claim 1, wherein
the control portion evaluates the crosstalk based on an amplitude of the first residual vibration and an amplitude of the second residual vibration.

13. The liquid ejecting apparatus according to claim 12, wherein
when the amplitude of the second residual vibration is not included in a third range specified based on the amplitude of the first residual vibration, the control portion evaluates that the crosstalk occurs.

14. A liquid ejecting apparatus comprising:
a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element; and
a control portion, wherein
the control portion
causes the detection portion to detect, as first residual vibration, the residual vibration caused by driving the first piezoelectric element and the second piezoelectric element with an ejection signal for ejecting the liquid, from the first piezoelectric element,
causes the detection portion to detect, as second residual vibration, the residual vibration caused by driving the first piezoelectric element with the ejection signal and driving the second piezoelectric element with a holding signal for not ejecting the liquid, from the first piezoelectric element, and
determines a waveform of the ejection signal and a waveform of the holding signal based on the first residual vibration and the second residual vibration detected by the detection portion.

15. A control method for a liquid ejecting apparatus including a liquid ejecting head that includes a first nozzle which ejects a liquid, a second nozzle which is disposed at a position different from a position of the first nozzle and ejects the liquid, a first piezoelectric element which corresponds to the first nozzle, a second piezoelectric element which corresponds to the second nozzle, a diaphragm which vibrates by driving at least one of the first piezoelectric element and the second piezoelectric element, and a detection portion which detects residual vibration of the diaphragm caused by driving at least one of the first piezoelectric element and the second piezoelectric element, the method comprising:
causing the detection portion to detect, as first residual vibration, the residual vibration caused by driving the first piezoelectric element and the second piezoelectric element with an ejection signal for ejecting the liquid, from the first piezoelectric element;
causing the detection portion to detect, as second residual vibration, the residual vibration caused by driving the first piezoelectric element with the ejection signal and driving the second piezoelectric element with a holding signal for not ejecting the liquid, from the first piezoelectric element; and
evaluating crosstalk between the first nozzle and the second nozzle based on the first residual vibration and the second residual vibration detected by the detection portion.
